(19) United States
(12) Patent Application Publication
(10) Pub. No.: US 2010/0257123 A1
(43) Pub. Date: Oct. 7, 2010

(54) SYSTEM AND METHOD FOR JUST-IN-TIME CAPTIAL INVESTMENT AND CONTROLLED COST INSURANCE

(76) Inventor: Sohail Abdul-Rahim Abdulla Jaffar Al Zarawani, Abu Dhabi (AE)

Correspondence Address: STROOCK & STROOCK & LAVAN LLP, 180 MAIDEN LANE, NEW YORK, NY, 10038, US

(21) Appl. No.: 12/817,654

(22) Filed: Jun. 17, 2010

Related U.S. Application Data
(62) Division of application No. 12/030,526, filed on Feb. 13, 2008.
(60) Provisional application No. 60/889,541, filed on Feb. 13, 2007.
(60) Provisional application No. 60/890,631, filed on Feb. 20, 2007.

(51) Int. Cl. G06Q 40/00

(52) U.S. Cl. 705/36 R

(57) ABSTRACT

A computer implemented method infuses pledged amounts into an account of an issuer just in time for use. A computer program establishes pledge agreements that are associated with accounts of asset holders. Access to the asset-holders' accounts through the computer network is confirmed, and those assets are monitored to ensure availability of those assets. An instruction received from the issuer causes the pledge agreements to be processed, identification of particular asset-holder accounts, and instructions to transfer at least a portion of the assets to the issuer account. In turn, the transferor is credited with an asset of the issuer in accordance with the terms of the pledge agreement. Optionally, pledge agreements terms are ranked to identify and select specific pledge agreements for the transfer step. Methods in accordance with the invention can facilitate the organization of pledged amounts into tranches for just-in-time financing in a variety of transactions.

This patent application claims the benefit of priority of U.S. Provisional Application Ser. No. 60/889,541, filed Feb. 13, 2007, entitled “5S Pledge: The Representation of Potential Value in a Certificate Which is Comprised of an Obligation to Provide Available Assets for Use in Investment,” and U.S. Provisional Application Ser. No. 60/890,631, filed Feb. 20, 2007, entitled “5S Pledge: The Representation of Potential Value in a Certificate Which is Comprised of an Obligation to Provide Available Assets for Use in Investment (With Securities Market Example),” which are hereby incorporated by reference in their respective entireties.

### FIELD OF THE INVENTION

This disclosure generally relates to methods of financing and investment as it relates to the financial services, insurance & reinsurance, investment, banking & finance industries.

### BACKGROUND OF THE INVENTION

Under English law and in common law jurisdictions derived from English law, there are broadly eight types of proprietary security interest that can arise. These are:

a. “true” legal mortgage

b. equitable mortgage

c. statutory mortgage

d. fixed equitable charge, or bill of sale

e. floating equitable charge

f. pledge, or pawn

g. legal lien

h. equitable lien

i. hypothecation, or trust receipt

Each of these is described in the aforesaid U.S. provisional applications.

There are a number of other arrangements which parties can put in place which have the effect of conferring security in a commercial sense, but do not actually create a proprietary security interest in the assets. For example, it is possible to grant a power of attorney or conditional option in favor of the secured party relating to the subject matter, or to utilize retention of title arrangement, or execute undated transfer instruments. Whilst these techniques may provide protection for the secured party, they do not confer a proprietary interest in the assets which the arrangements relate to, and their effectiveness may be limited if the debtor goes into bankruptcy.

It is also possible to replicate the effect of security by making an outright transfer of the asset, with a provision that the asset is re-transferred once the secured obligations are repaid. In some jurisdictions, these arrangements may be re-characterized as the grant of a mortgage, but most jurisdictions tend to allow the parties freedom to characterize their transactions as they see fit. Common examples of this are financings using a stock loan or repossession agreement to collateralize the cash advance, and title transfer arrangements (for example, under the “Transfer” form English Law credit support annex to an ISDA Master Agreement (as distinguished from the other forms of CSA, which grant security)). In the United States, under Article 9 of the Uniform Commercial Code, a security interest is a proprietary right in a debtor's property that secures payment or performance of an obligation. A security interest is created by a security agreement, under which the debtor grants a security interest in the debtor's property as collateral for a loan or other obligation.

A security interest grants the holder thereof a right to take remedial action with respect to the property that is subject to the security interest upon the occurrence of certain events—the classic example being the non-payment of a loan. The holder may take possession of such property in satisfaction of the underlying obligation, or, more common, the holder will sell such property (either by means of public auction or private transfer) and apply the proceeds of such sale to the underlying obligation. To the extent that the proceeds of the sale exceed the amount of the underlying obligation, the debtor is entitled to the excess; and, to the extent that the proceeds of the sale do not exceed the amount of the underlying obligation, the holder of the security interest is entitled to a deficiency judgment pursuant to which the holder can institute additional legal proceedings aimed at recovering the full amount of the underlying obligation from the debtor.

In the U.S. the term “security interest” is often used interchangeably with “lien”; that being said, the term “lien” is more often associated with real property collateral than with personal property collateral. Security interests in most types of personal property are governed in the United States by Article 9 of the Uniform Commercial Code. A security interest is typically granted by a contract called a “security agreement”. Upon execution of such contract by the debtor, the security interest exists with respect to the property in question assuming that the debtor has an ownership interest or ownership-like interest therein and assuming that some form of value has been conferred by the holder of the security interest to the debtor (such as a loan). Also, upon execution of such contract, the security interest becomes enforceable between the holder thereof and debtor; however, in order for the rights of the holder of the security interest to become enforceable against third parties, the holder must “perfect” the security interest. Perfection is typically achieved by filing a document called a “financing statement” with a governmental authority (often, the secretary of state in which a corporate debtor is incorporated—although there are various rules applicable to natural persons and certain types of corporate debtors), however, perfection can also be obtained by taking possession of the collateral in question (assuming the collateral in question is tangible property). Absent “perfection”, the holder of the security interest will not be able to enforce its rights in the collateral vis-á-vis third parties, such as other creditors who claim a security interest in the same collateral or a trustee in bankruptcy.

Liquidity risk arises from situations in which a party interested in trading an asset cannot do it because nobody in the market wants to trade that asset. Liquidity risk becomes particularly important to parties who are about to hold or currently hold an asset, since it affects their ability to trade.

Liquidity risk is financial risk due to uncertain liquidity. An institution might lose liquidity if its credit rating falls, it experiences sudden unexpected cash outflows, or some other event causes counterparties to avoid trading with or lending to the institution. A firm is also exposed to liquidity risk if markets on which it depends are subject to loss of liquidity.

Liquidity risk tends to compound other risks. If a trading organization has a position in an illiquid asset, its limited ability to liquidate that position at short notice will compound its market risk.

Equity risk is the risk that one's investments will depreciate because of stock market dynamics causing one to lose money.

The measure of risk used in the equity markets is typically the standard deviation of a security's price over a number of periods. The standard deviation will delineate the normal fluctuations one can expect in that particular security above and below the mean, or average. However, since most investors would not consider fluctuations above the average return as “risk,” some economists prefer other means of measuring it.

Interest rate risk is the risk that the relative value of a security, especially a bond, will worsen due to an interest rate increase. This risk is commonly measured by the bond's duration.

Horizon Risk occurs primarily with fixed income securities, such as bonds, when the buyer locks in a rate for an extended period of time and the expected return on the investment decreases as a result of changes in the inflation rate over time.

Credit risk is the risk of loss due to a debtor's non-payment of a loan or other line of credit (either the principal or interest (coupon) or both).

Most lenders employ their own models (Credit Scorecards) to rank potential and existing customers according to risk, and then apply appropriate strategies. With products such as unsecured personal loans or mortgages, lenders charge a higher price for higher risk customers and vice versa. With revolving products such as credit cards and overdrafts, risk is controlled through careful setting of credit limits. Some products also require security, most commonly in the form of property.

There remains a need in the art, however, for structures and methodologies that provide access to capital in a just-in-time manner so as to provide necessary liquidity without mortgaging or otherwise committing the resources of the capital recipient until there is a need for the capital. The present invention addresses this and other needs.

### SUMMARY OF THE INVENTION

In accordance with an aspect of the invention, a computer implemented method is provided that infuses a pledged amount into an account of an issuer in a just-in-time manner. In accordance with this method, a host machine connected to a distributed computer network executes a computer program that establishes one or more pledge agreements that are associated with accounts of respective asset holders. Each of the pledge agreements has terms, including but not limited to an amount pledged by the asset holder. The method confirms access to the asset-holder's account over the computer network. Any so-established asset holder accounts is monitored over the computer network to ensure a current availability of the associated prescribed asset. The method responds to an instruction received from the issuer at the host machine by processing the terms of the pledge agreements, identifying particular asset-holder accounts as a result of the processing and instructing a transfer of at least a portion of the prescribed assets from such accounts to the issuer account, and, for each account having at least the portion of the prescribed assets being transferred, crediting the account holder with an asset of the issuer in accordance with the terms of the pledge agreement.

In accordance with a further aspect of the invention, the processing step of the foregoing method can comprise using defined rules to rank the pledge agreements in accordance with at least one defined criterion. Also, the identifying step can identify one or more pledge agreements that have a higher rank than other pledge agreements, if the pledge agreements are so ranked.

In accordance with still another aspect of the invention, a computer implemented method for facilitating just-in-time financing for an entity comprising the steps of establishing pledge agreements, confirming access to accounts associated with the pledge agreements, and responding to instructions from entities desirous of financing with further actions that cause asset transfers between the account-holders and the entity. The establishing step establishes at a host machine connected to a distributed computer network one or more pledge agreements each having terms including (i) the pledged amount of a prescribed asset associated with an account of a respective asset holder, and (ii) a description of an asset to be acquired upon transfer of the pledged amount. The confirming step confirms access to the asset-holder account over the computer network and, thereafter, monitors over the computer network any established asset holder accounts to ensure a current availability of the associated prescribed asset. The further actions taken in response to an instruction received from the entity at the host machine include: (i) processing the terms of the pledge agreements using defined rules; (ii) identifying from among the processed pledge agreements one or more asset-holder accounts having the current availability for infusing at least a portion of the pledged amount into an account of the entity; (ii) instructing the identified accounts to transfer at least a portion of the prescribed assets in the identified asset-holder accounts to the entity account; and (iv) for each account having at least the portion of the prescribed assets transferred, crediting the account holder with an asset satisfying the description.

In accordance with another aspect of the invention, a computer implemented method is provided that organizes pledged amounts into tranches for use by a party for just-in-time financing. In accordance with this aspect, a host machine connected to a distributed computer network contains one or more pledge agreements. The pledges each have terms, including the amount of a prescribed asset pledged by an asset holder, and a benchmark description of an asset to be acquired by the asset holder upon transfer of the pledged amount. The host machine confirms access to the asset-holder account over the computer network, and thereafter, monitors any established asset holder accounts to ensure a current availability of the associated prescribed asset. A tranche of pledge agreements is defined by matching the benchmark description of any pledge agreements within the host machine, and the beneficial ownership of the tranche is/can be assigned to a third-party. Upon receiving instructions from the party, the host machine processes the term of the pledge agreements using defined rules, identifies asset-holder accounts having the current availability for infusing at least a portion of the pledged amount into an account of the party, instructs the identified asset-holder accounts to transfer at least a portion of the prescribed assets to the party account; and crediting the asset-holder account with an asset satisfying the benchmark description.

In accordance with a further aspect of the invention, the crediting step of the foregoing method can comprise pricing the asset that satisfies the benchmark-description and providing the account-holder with a quantity of said determined in accordance with the pricing step and a value of the portion of the prescribed assets transferred to the party account.

### BRIEF DESCRIPTION OF THE DRAWING FIGURES

Aspects and features of the invention will be more readily apparent from the following Detailed Description, which proceeds with reference to the accompanying drawings, in which:

FIG. 1 shows a schematic diagram of an illustrative operating environment for the present invention;

FIGS. 2-6 are flowcharts illustrating an implementation of a computer program for procuring asset holders and attaining just-in-time financing according to the present invention;

FIG. 7 depicts a schematic illustration of an implementation of a database that stores data of the present invention;

FIGS. 8A-J illustrate contents of exemplary data forms stored in the memory of the server for inputting data into the server and saving it onto the database.

FIG. 9 depicts using the 5S Pledge in an SPV structure.

FIG. 10 depicts using the 5S Pledge to increase a reinsurance company's capital without soliciting direct investment.

FIG. 11 depicts applying the 5S Pledge to the stabilization of securities markets.

### DEFINITIONS OF CERTAIN TERMS

The term “cleared funds” as used herein means funds actually received by the investment manager from a 5S Pledge holder.

The term “holder” as used herein means the party to the 5S Pledge transaction that has the obligation to have funds available for the (investment) manager according to the terms of the 5S Pledge contract but has not yet contributed cleared funds to the investment manager. Asset holder is used interchangeably with the holder. Holder also means “investor” where the context so requires.

The term “investment manager” as used herein means the party (or agent or service provider of the party) to the 5S Pledge transaction that has the right, but not the obligation, to draw on the funds of the 5S Pledge holder according to the terms of the 5S Pledge contract. Investment manager, manager, and issuer are used interchangeably except where the context otherwise requires. Thus, in implementations in which an investment manager acts as a service provider on behalf of an issuer or an investment bank, these entities are distinct and the program code that executes the inventive methods is controlled by the investment manager rather than the issuer.

The term “investor” as used herein means a holder of a 5S Pledge who has contributed cleared funds to the investment manager.

The term “closed system environment” as used herein refers to a system where relationships between participants in the system/environment are defined, bound and regulated by in some fashion that helps to ensure performance of obligations through either contract, regulatory authority, convention, etc.

The term “Multi-Party Organization” or “MPO” as used herein to refer to organizations where relationships between participants in the organization are defined, bound and regulated in some fashion that helps to ensure performance of obligations through either contract, regulatory authority, convention, etc. Examples of MPO's include but are not limited to: NASDQ, NYSE, and LSE; US Federal Banking System and banking systems in general; and insurance organizations/markets such as Lloyds of London.

Description of Certain Implementations of the Invention

While specific structures, configurations and arrangements are discussed below, it should be understood that this is done for illustrative purposes only. A person of ordinary skill in the pertinent art will recognize that other structures, configurations and arrangements can be used without departing from the spirit and scope of the present invention.

By way of overview and introduction, the present invention concerns a system and method for enabling a company to arrange financing without committing its resources until the financing is actually required. As such, the invention provides a system and method in which financing can be secured by the company in a just-in-time matter in exchange for assets of the company, such as stock options, bonds and other negotiable instruments or collateral. In connection with the system and method described below, the company identifies prospects such as high net worth individuals, hedge funds and pension funds, other companies, and other resources that have assets that can be used to provide the financing that the company needs to satisfy the company's capital infusion requirements. Each of these entities establishes electronic communication channels which permit just-in-time exchange of the assets pledged by such individuals for the negotiable instruments or collateral of the company. The invention also provides a mechanism for using this financing as a form of controlled cost insurance.

In another implementation, the entity raising capital can select from among one or more tranches of potential investors, and can either commit its negotiable instruments or collateral in exchange for the assets pledged by the tranche, or can arrange for the transfer of an asset satisfying a benchmark description, as described further below.

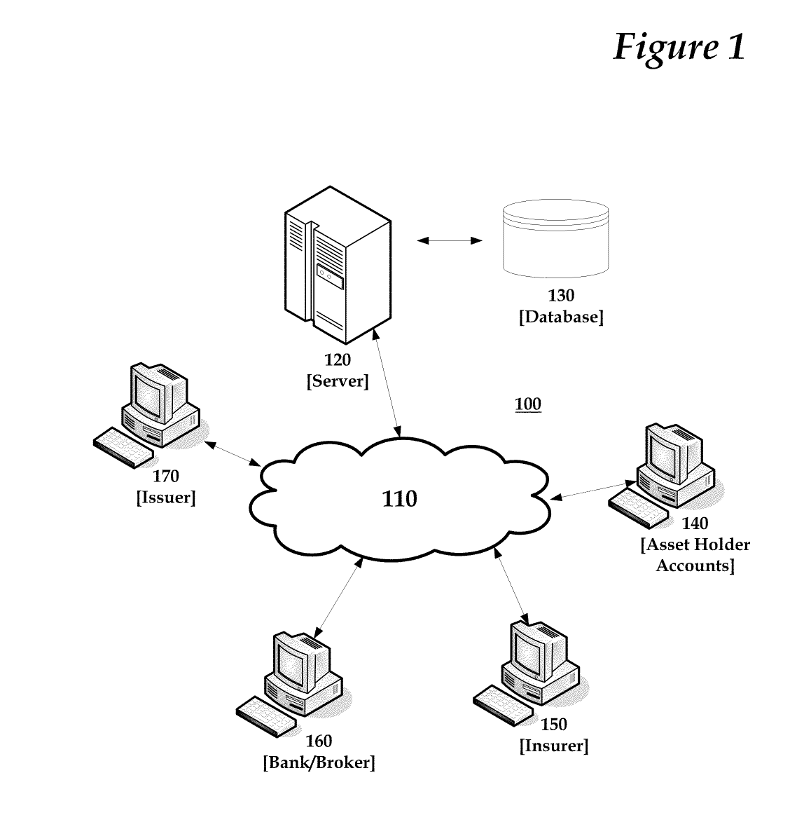

### FIG. 1: Hardware Configuration

Referring now to FIG. 1, a hardware arrangement suitable for implementing the invention is illustrated. An arrangement 100 of components communicate with one another through a network 110 such as the internet or other distributed computer network. The system and method of the present invention comprise a series of computer instructions that collectively comprise computer code executing in a processor of at least one of the machines connected to the network, such as host server 120. Using these instructions, and with reference to a securely maintained database 130, the host server 120 coordinates and manages communications between and among investor prospects (having the asset holder accounts 140 suitable for pledging funds to the company) and accounts of issuers 170 of negotiable instruments and other collateral (which are associated with the companies interested in establishing arrangements for capital infusions from investor prospects). In some implementations, issuer account 170 is not the same as the entity that is desirous of a capital raise, but rather the negotiable instruments are fungible and are selected in accordance with the terms of a tranche of investor prospects having the same terms in their pledge agreements, as discussed more fully below.

The issuer computer 170 is operated by an investment manager or officer of the company that is desirous to raise financing and that person or that entity establishes policies and/or rules that are provided to the computer code executing in the host server 120 and which govern the manner of execution of the system and method herein below.

Preferably, the host server 120 and the database 130 are maintained behind the secure firewall. Optionally, the issuer computer 170 is co-located with the server and database, and can be the same machine, in certain implementations.

The holder/investor machine 140 typically is a machine that is associated with the account of a person who has assets to invest. By way of example, the holder/investor machine 140 can comprise a secure account maintained at a brokerage house or with a bank. Such accounts have the individual asset holder/potential investor as the registrant on the account with the authority to allocate funds for investments, including pledges to the issuer computer 170, in accordance with a broad aspect of the present invention.

The hardware arrangement 100 typically includes other computer systems that are communicatively coupled thereto and that are used in furtherance of other aspects of the present invention. For example, third party bank machines 160 (including machines of credit agencies) and machines 150 associated with insurance companies, and other machines not illustrated can be part of the hardware arrangement 100.

Each of the components in the illustration of FIG. 1 communicates in a conventional manner over conventional communication lines, or in some implementations in a wireless manner, using protocols such as http, https, SMS, etc.

Each of the machines has a typical complement of other components and software including, without limitation, respective processors, memory circuits, communication ports, operating systems and other software (e.g., web browsers).

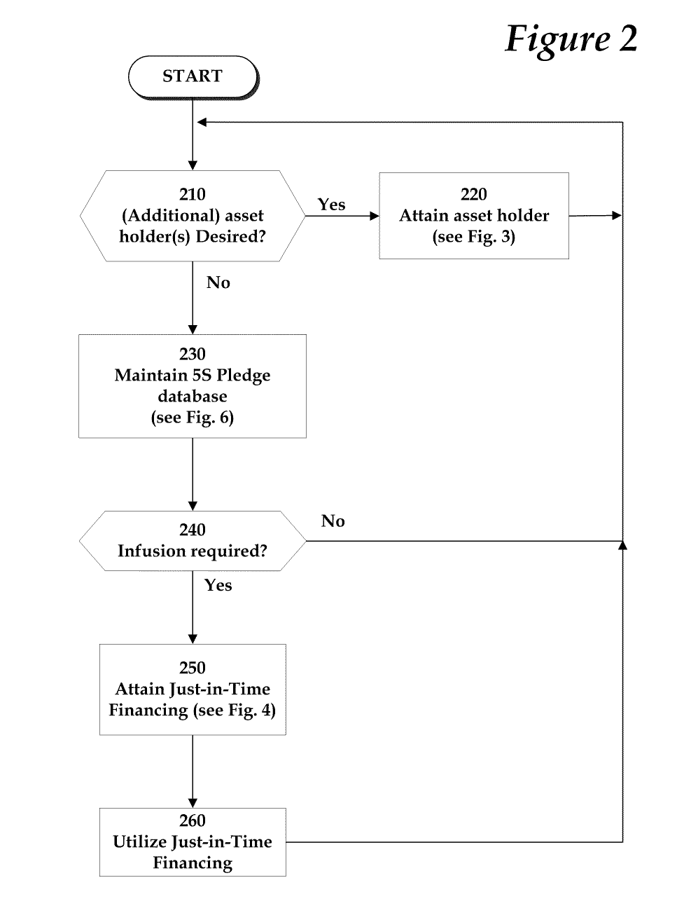

### FIG. 2: Process Overview

The 5S Pledge is a new invention and method for financing and insurance that allows for flexibility, efficiency and the mitigation of risks associated with traditional investing and insurance. FIG. 2 depicts an overview of the processes for obtaining asset holders to back a 5S Pledge agreement and for obtaining just-in-time financing. The term “5S Pledge” refers to an agreement as in the exemplary embodiment, but the principals of the invention can be applied regardless of the term used for the agreement, and is sometimes more generally referred to herein as a “pledge agreement.”

At block 210, an issuer decides whether there is a desire to have access to (additional) financing or credit enhancement, and thereby whether the issuer requires (additional) 5S Pledges from asset holders. Reasons the issuer desires financing can include having access to funds available for large purchases, such as purchasing companies, protecting against market conditions, such as increases in borrower interest rates, and protecting against periods of low cash flow. In some implementations, the issuer desires to have access to financing as a form of insurance. For example, the issuer can then insure against a decline or interruption in cash flow, an economic downturn, and/or during an unforeseen or catastrophic event.

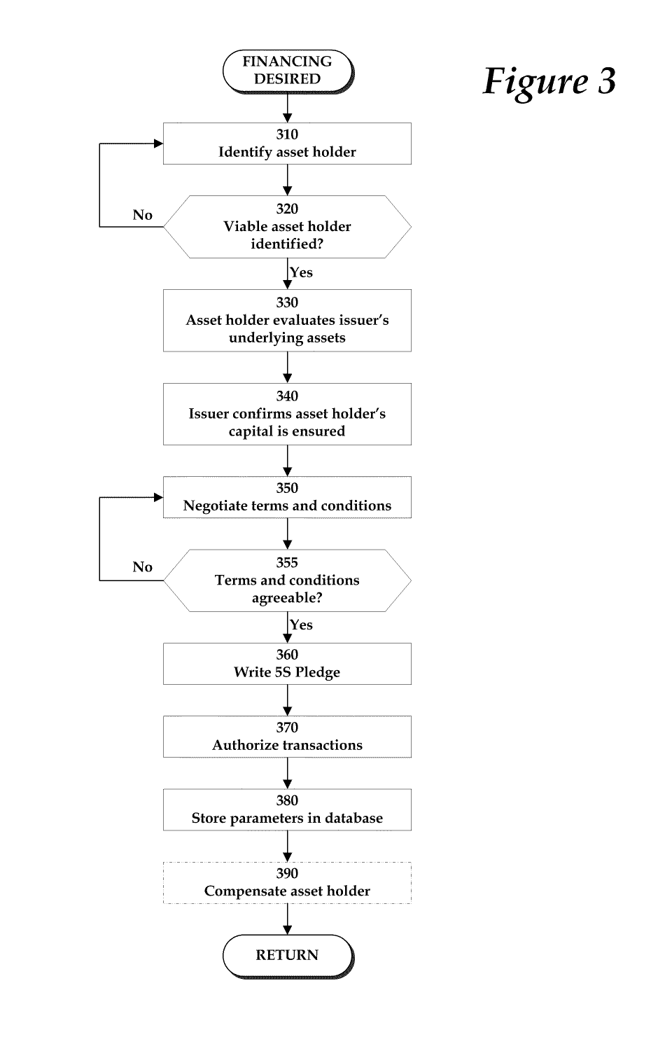

If an issuer wants to have access to additional funds but does not want to commit to utilizing those funds, the issuer attains/procures asset holders and enters into a 5S Pledge agreement with them at block 220, the process details of which are described at FIG. 3. The issuer can repeat the process of obtaining access to additional funds by procuring asset holders indefinitely in order to gain access to as many additional funds as required. Additionally, the process of obtaining asset holders can occur in sequence or in parallel with other processes.

The terms and conditions of any authorized 5S Pledge agreement, as well as other information related to obtaining asset holders and utilizing just-in-time financing, are routinely maintained at block 230, the process details of which are described at FIG. 6. Such maintenance includes updating pledge viability, asset holder account data, issuer asset data, monitoring over established asset holder accounts to ensure current availability of the associated prescribed asset, as well as other pertinent information. Additionally, the maintenance and system monitoring can be performed repeatedly.

If the issuer requires no capital infusions, the issuer can continue procuring additional asset holders. An issuer that is satisfied with the aggregate value of secured pledges can also simply allow time to pass until a capital infusion is required or the pledge reaches maturity and expires. For example, the pledge can expire by reaching maturity or according to a change in the terms and conditions of the 5S Pledge agreement. In some cases, just-in-time financing will never be required; however, for some issuers in certain industries, it is beneficial to the issuer to make arrangements to continue to procure asset holders/investors, so as, for example, to have access to readily available financing, to increase the equity to debt ratio, or the like. Additionally, if an issuer has no need for the financial backing that a 5S Pledge provides, the issuer can cancel the pledge in accordance with the terms and conditions of the agreement.

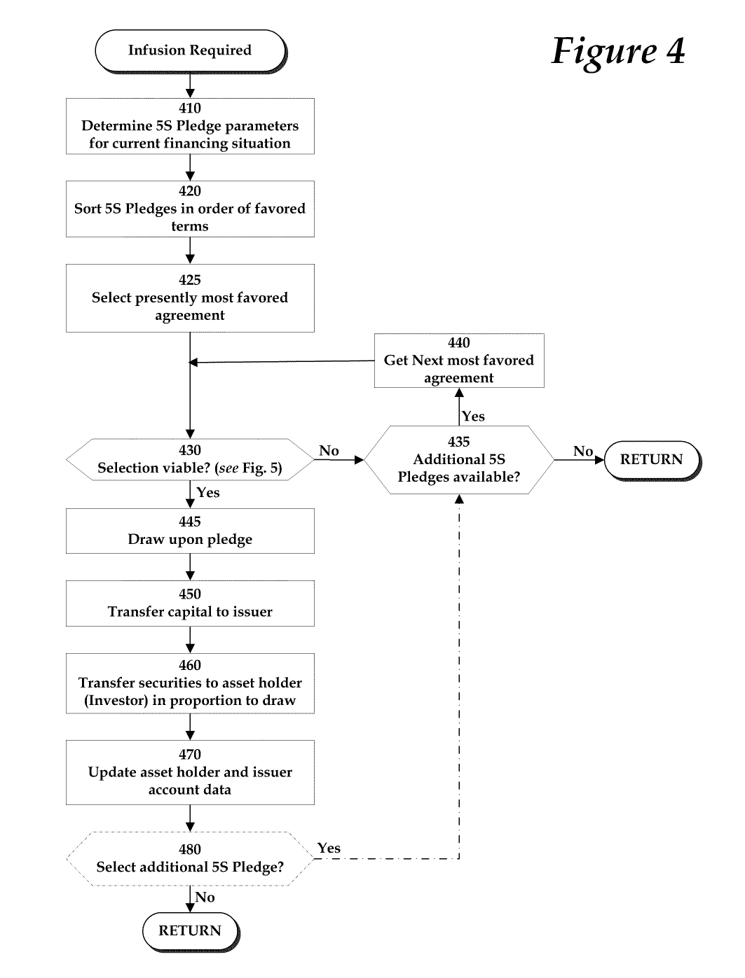

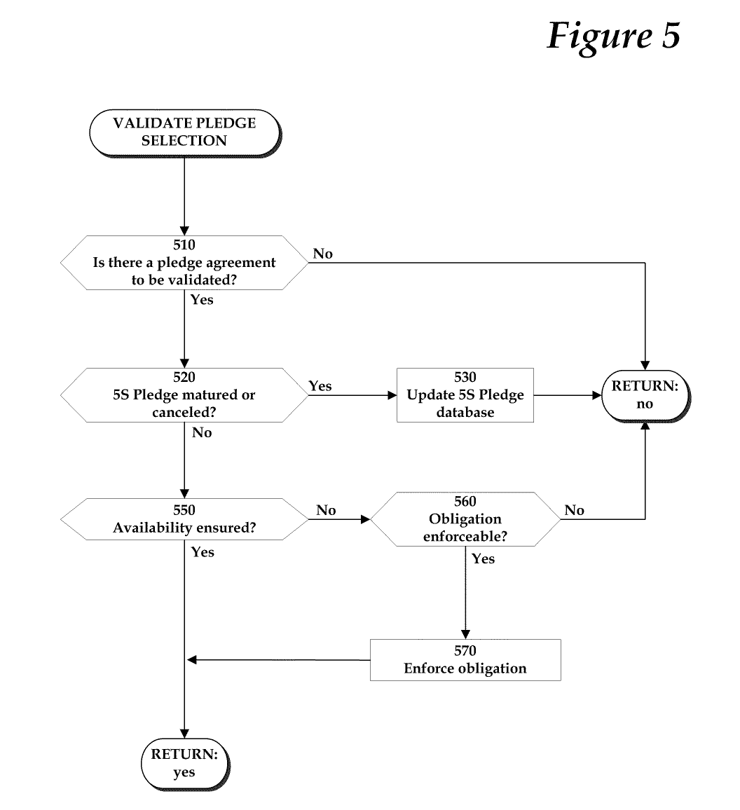

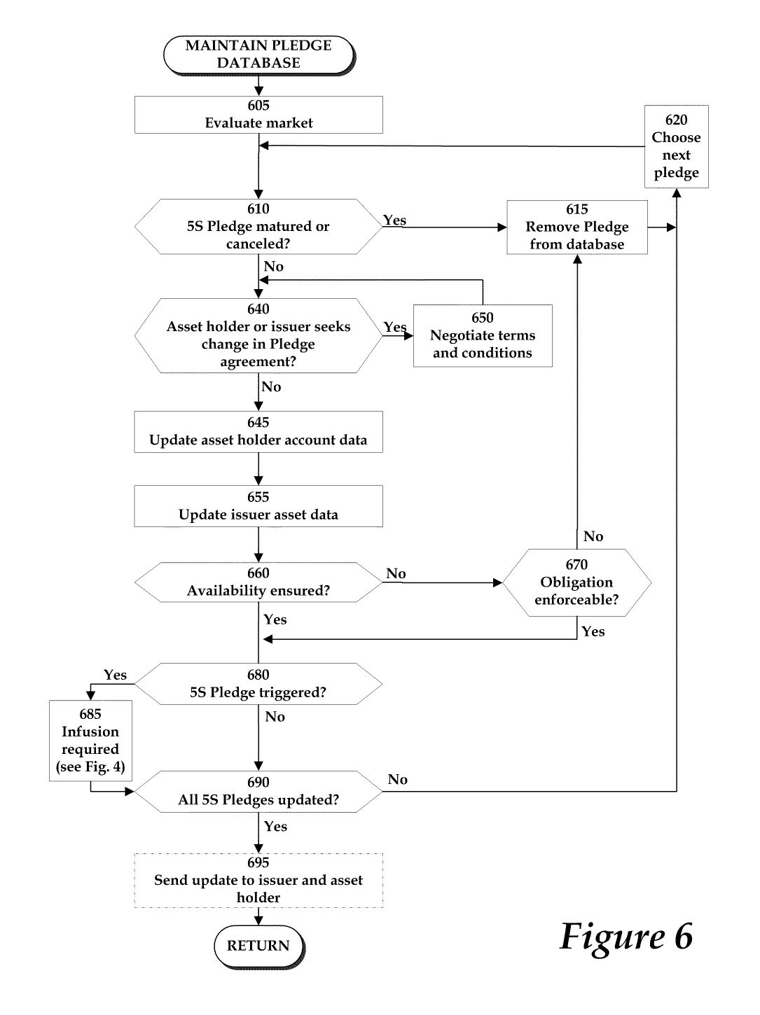

If an infusion of capital is required, the issuer obtains just-in-time financing at block 250 by selecting any favored pledge and exchanging securities for the asset holder's capital, according to the processes depicted in FIG. 4. The issuer, in keeping with the terms and conditions of the 5S Pledge agreement, has control over this event. At block 260, the issuer can utilize the attained capital according to the issuer's financing needs. Such needs can include, for example, purchasing a company or infrastructural capital. As stated above, such needs can also include capital to guard against a decline or interruption in cash flow, an economic downturn, and/or during an unforeseen or catastrophic event.

Of course, the blocks in FIG. 2 can be processed by the processor according to the sequence depicted in FIG. 2 or according to an alternate sequence. For example, obtaining investor prospects 220, maintaining the database 230, and obtaining just-in-time financing 250, can be performed in parallel. Additionally, if the issuer has no need for obtaining or utilizing just-in-time financing, only blocks corresponding to obtaining investor prospects 220 and maintaining the database 230 can be executed.

The overview of FIG. 2 described above is provided from the perspective of an issuer, but the same principals generally apply to service providers who act as intermediaries between a company desiring to raise financing and asset holders, or tranches of asset holders or other categories of asset holders (e.g., debt or equity). When the process comprises a program operating under control of an investment manager who is distinct from the issuer, the steps illustrated further comprise managing requests for financing by companies in view of the asset holders that have been registered as prospective investors. As such, the decision at block 240 includes receiving requests for financing and receiving an identification of the company making the request (optionally, receiving this information together), and coordinating such requests with any asset holders who have registered with the investment manager. A particular asset of the company (or of a third party) is selected to be the consideration for any infusion of assets to the company from the asset-holder's, and such selection is made in accordance with the terms of the pledge agreements with the asset holders, or tranches of asset holders.

### FIG. 3: Financing Desired

FIG. 3 depicts a process for enlisting asset holders who are willing to pledge assets in exchange for an investment in the issuer's company, and is presented from the perspective of a company desiring to raise financing without committing its assets at the time of the obligation. An analogous process flow is performed when an investment manager acts as an intermediary as between a company desiring to raise financing and asset holders, or tranches of asset holders.

The process beings at block 310, wherein an issuer desiring Just-in-Time financing identifies any asset holder that has interest or potential interest in pledging assets to the issuer in exchange for a potential investment in the issuer's company and/or some other consideration for pledging such assets. In some implementations, the issuer approaches an asset holder selected from a list of asset holders stored in database 130. In other implementations, the issuer finds an asset holder by other, conventional means, such as, by meeting the asset holder at a trade show or a conference, contacting a bank or venture capital firm, contacting a company with interest in the issuer's business, or the like. In still additional implementations, any asset holder desiring to pledge assets approaches the issuer, or any representative of the issuer, to propose the exchange above described.

The issuer determines whether any identified asset holder is a viable prospective financial partner at block 320. If financing is desired but no viable asset holder is immediately identified, the issuer continues to identify prospects until an asset holder is identified. For example, an issuer can choose to forgo dealing with an asset holder if there is a conflict of interest.

On the other hand, if a viable asset holder is identified, the underlying assets of the issuer are evaluated at block 330. By this process, the asset holder can form reasonable expectations about the present and future value of the issuer's financial assets. Assets subject to evaluation can include the issuer's outstanding securities, intellectual property holdings, human resources, management structure, prospective financial requirements, growth potential, cash flow, and other company properties or characteristics. In the event that the process is performed by an intermediary, the underlying assets that are subject to transfer upon a company exercising the pledge agreement are similarly made available for evaluation.

Asset valuations can be processed by server 120, or, in some cases, by hardware or entities in communication with the server over the network 110. For example, the issuer can send a message containing data regarding the above valuation parameters to the server, and the server's processor can evaluate the assets according to code stored in the memory unit. In further implementations, the server generates and sends messages to the computers associated with the issuer and holder. These respective computers can then process the valuation messages generated by the server consistent with their individual criteria. In still further implementations, the valuation messages generated by the server can be appraised by the issuer and the holder.

The issuer confirms that the asset holder's capital is ensured at block 340. In this way, the issuer can form reasonable expectations about the likelihood that it will be able to draw on the asset holder's capital in times of need. There are many ways in which the asset holder's capital can be ensured. For example, the asset holder can provide direct access to accounts from which the issuer can withdraw capital, authorize the issuer to utilize the asset holder's credit, provide testimonials from creditors, provide documentation from external credit assessments, authorize the issuer to utilize the asset holder's brokerage accounts, and use other conventional methods. In another example, the asset holder can ensure accessibility to funds by bringing in a third party, such as an insurer, and administrator, a trustee, a guaranteur, or the like.

Ensuring capital includes determining the amount of capital that can reasonably be pledged by the asset holder. In one implementation, the issuer analyzes the financial statements and financial holdings of the asset holder to determine availability of liquid capital. In another implementation, the issuer analyzes the financial standings of the third party. The financial standings include credit history, accounts, rating (A, AA, AAA, etc.), and the like.

In some implementations, the asset holder is not able to adequately ensure the capital. An issuer will sometimes choose to forgo an asset holder that cannot ensure availability of the capital, and instead identify a different asset holder. At other times, the issuer continues to include such an asset holder in the pool of financing prospects, but will write a 5S Pledge agreement to sell the issuer's underlying securities to the asset holder at a premium if the asset holder's assets are drawn on by the issuer.

The issuer and the asset holder negotiate the terms and conditions of the 5S Pledge agreement at block 350, based partially on the valuation of the issuer's underlying assets, the compensation that the asset holder can receive, the extent to which the asset holder's capital is ensured, and the likelihood that the 5S Pledge is converted into the underlying asset. For example, the issuer is likely to offer an asset holder securities at a discount if the asset holder's capital is highly ensured. In another example, an asset holder is likely to pledge a higher amount of capital to the issuer if the asset holder believes that the issuer's securities will increase in value. In some implementations, the asset holder receives some quarterly or yearly percentage of the profits, or periodic premium payments, from the issuer.

The financial situations of the issuer and the asset holder can be inferred by conventional methods from the analyses conducted at blocks 330 and 340 or by other external means such as analysis done by credit rating agencies, broker/dealers.

During negotiations, the issuer presents the holder with at least one security package option. In some implementations, the issuer will offer previously created/standardized security packages (stored in database 130) to the asset holder. In other implementations, the issuer creates a new security package for the asset holder, and can account for nuances of the present negotiation. Such nuances can be, for example, the amount of pledged capital, the extent to which the asset holder's capital is ensured, the proposed pledge maturity date, and the like. In some implementations, a program processed by server 120 suggests security packages (i.e. combinations of stocks, bonds, and other securities) that the issuer can offer to the asset holder during the negotiations. In additional implementations, the issuer can interact with the code on the server over the network 110 to provide feedback and input, to the code, with regard to the security packaging. In still further implementations, the issuer packages its own securities, and sends the package characteristics to the server over the network, whereby the processor parses and stores the message in database 130.

Of course an issuer can also issue standardized 5S Pledge agreements, which an asset holder can choose to purchase. For example, the standardized pledge agreements can be issued in classes A, B, C, D, etc. such that class “D” pledges pay, or promise to provide, a higher premium, or other form of greater compensation (e.g., relatively more stock) to the asset holder when compared with “A” class issuances. In some implementations, the standardized pledges can be pooled and/or tranched on a secondary market.

In another implementation, the issuer simply puts forth a “benchmark” which is a description of an asset to be acquired upon transfer of a pledged amount that is suitable to define the asset in a manner that allows evaluation by an asset holder when deciding whether to enter into a pledge agreement, such as indicated at block 330. The issuer or party can then define a tranche of pledge agreements by matching the benchmark description of any pledge agreements within the host machine. The beneficial ownership of such tranche can be assigned to any eligible third party (if applicable), in accordance with the 5S Pledge agreement. A tranche can be defined on the basis of a single pledge agreement, but typically will comprise a plurality of pledge agreements specifying similar consideration in exchange for depletion of the pledged assets.

Similarly, the asset holder evaluates the proposed security package, and offers at least one pledge of assets. The pledged amount can include a plurality of prescribed assets. The pledge can depend on, for example, the security packages compiled by the issuer, the valuation of the issuer's underlying assets, the prospectus/offering documents of the issuer, market conditions, and the like. In some implementations, the asset holder will use a code executed by the processor of a computer to create a pledge offer.

The issuer and asset holder need to agree on many different terms and conditions during negotiations. These terms and conditions can include pledge maturity date, security/capital exchange rate agreement, cancellation policies, enforceability conditions, pledge trigger conditions, restrictions on use of capital, payout of periodic payments, among others. In some implementations, one or more third parties can be used to assist during negotiations. The third parties can advise on the security mix offerings, security growth prospects, pledge amount, legal issues, company growth potential, company structure, pledge maturity timeframes, as well as other business and/or legal issues that the issuer, asset holder, and other involved parties require. These terms are can be completed or stored electronically until completed through communications across the network 110.

The issuer and the asset holder evaluate each other's offerings at block 355. If the offerings are substantially different, the parties return to block 350 to renegotiate the terms and conditions. If the offerings are substantially similar, the parties can choose to enter into a 5S Pledge agreement.

The 5S Pledge agreement is finalized and sent to server 110 for processing, in block 360. In some implementations, the issuer, the asset holder, or a third party (lawyer, financial specialist, negation mediator, etc.) send a message with the terms and conditions of the 5S Pledge agreement to server. The message can contain a newly composed document containing the terms and conditions of the pending 5S Pledge, or it can be preexisting pledge template filled with the same content.

During processing, the processor parses the message with the 5S Pledge agreement, extracts the issuer's and asset holder's account information, and creates authorizations for the transactions stipulated in the 5S Pledge agreement, and confirms/authenticates the pledge.

The authorizations are created according to conventional protocols at block 370, and can include account keys to access the bank accounts, credit card accounts, brokerage accounts, and the like. In some implementations, server 110 establishes communication with the entities that contain the above mentioned financial accounts to confirm the legitimacy of the information provided by the issuer and the asset holder. For example, the server can confirm access to the asset-holder account by transferring a nominal sum from the asset-holder account to the issuer account, obtaining an available credit limit of the asset-holder account, or obtaining a balance of the asset-holder account. Upon processing and authorization, 5S Pledge agreements are binding.

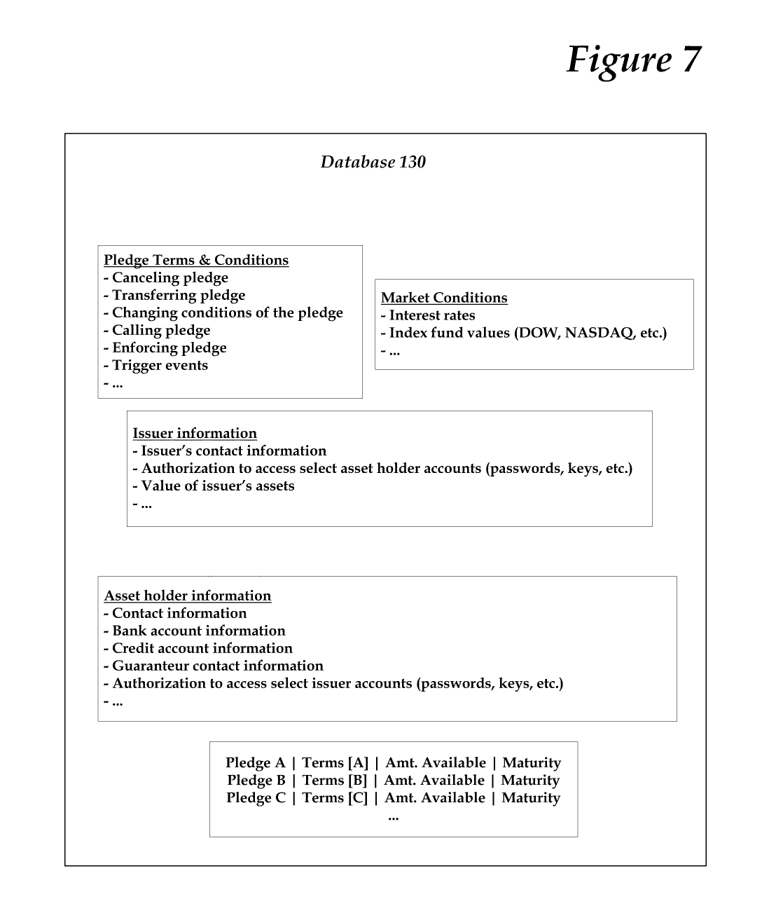

The parsed 5S Pledge parameters, authorizations, and other relevant data are stored in database 130, at block 380. See FIG. 7 for an example of the type of information stored in said database. This information can be used, in part, to confirm current availability of assets that underlie a given pledge agreement with an account holder, and to tranche like-pledge agreements together, if they are not already part of a common tranche.

If the 5S Pledge agreement stipulates that a payment is due to the asset holder for guaranteeing available capital, the asset holder is compensated at block 390. In some implementations of the 5S Pledge agreement the asset holder is not compensated with capital, but instead receives more favorable 5S Pledge agreement terms and conditions. In some implementations, an issuer is very likely to draw on the 5S Pledge. In such a case the asset holder can pledge capital without requiring compensation, and instead pledges the assets only for the promise and potential of becoming an investor.

Once the 5S Pledge agreement is made, the issuer can behave as if the issuer has the capital stipulated in the agreement. For instance, the issuer can use the pledged capital as leverage in business transactions, and enjoy the benefits of the increased assets to liabilities ratio on the balance sheet. In the meantime, the asset holder can continue to use their capital. For instance, the asset holder can continue to purchase securities on the free markets, or take advantage of other liquid investment opportunities.

### FIG. 6: Maintain 5S Pledge Agreement Database

5S Pledge agreement databases are subject to change, and thus can be maintained according to a process such as shown in FIG. 6 once they have been created. In one implementation (illustrated in FIG. 6) each 5S Pledge agreement in database 130 is reviewed sequentially. Other implementations can have different schemes for updating the database. In either case, the process of FIG. 6 proceeds under control of computer code executing in a machine, such as host server 120.

The processor evaluates the market conditions at block 605. Database 130 is updated to include current fund indexes (DOW, NASDAQ, S&P500, and other world indices), interest rates, and the like. In some implementations the processor runs computer code to determine the level of risk in the market, and other useful values for determining the terms and conditions of 5S Pledge agreements.

At block 610, the processor determines whether the 5S Pledge has matured, or been cancelled. To determine maturity, the processor compares the 5S Pledge agreement maturity date of the first agreement found in the database with the present date. If the maturity date is before the current date, the pledge is mature. To determine whether the pledge has been cancelled, the processor checks whether it has received a cancellation notice, in accordance with the terms and conditions of the 5S Pledge. If the pledge has matured or been cancelled, it is removed from the database at block 615, and the next 5S Pledge agreement is accessed from the database for maintenance at block 620.

Block 640 determines whether the asset holder or the issuer seek a change in the pledge agreement. In some implementations, an asset holder or issuer can seek a change in the pledge agreement due to, for example market conditions. When interests rates change, the asset holder or issuer can face a different investment landscape, and would therefore like to change the terms and conditions of the original 5S Pledge agreement.

If either issuer or asset holder would like to change term and conditions of the 5S Pledge, the parties enter negotiations at block 650. The issuer and asset holder can renegotiate terms and conditions as specified in the original 5S Pledge agreement. These terms and conditions can include pledge maturity date, security/capital exchange rate agreement, cancellation policies, enforceability conditions (such as availability of third party guarantee of funds, etc.), pledge trigger conditions, restrictions on use of capital, among others. In some implementations, one or more third parties can be used to assist during negotiations. The third parties can advise on the security mix offerings, security growth prospects, pledge amount, legal issues, company growth potential, company structure, pledge maturity timeframes, as well as other business and/or legal issues that the issuer, asset holder, and other involved parties require. Additionally, computer programs executed by the processor of server 120 can be used to assist in determining prices and terms of the new agreement. Following negotiations, the program loops back to block 640, so that the parties can re-evaluate and determine whether they seek additional changes in the pledge agreement.

If no requests for changes to the 5S Pledge agreement have been passed to the processor, the asset holder account data is updated in accordance with block 645. Asset holder accounts are monitored and maintained to keep credit scores as well as bank, asset, and credit information current. One reason to keep information current is to expedite the exchange of capital and financial interest (i.e., securities) between the issuer and the asset holder/investor. In some implementations, the server accesses authorization codes from the database, and sends the authorization key with a message to the asset holder's bank. The bank processes the authorization key and the message, and sends a message with the asset holder's current account information to the server. The account information is, for example, account number, account balance, availability of funds in the amount obligated, and the like. The account is for example, a bank account, a brokerage account (securities), another asset account, or the like. The server compares the bank message containing the asset holder's account information with the information stored in the database. If the information contained in the bank message is different from the information contained in the database, the information in the database is erased and substituted with the new information. If account access is denied, there is reason to believe that the accounts are closed, or have insufficient funds such that the amount of capital or assets in the account is not in compliance with the 5S Pledge agreement, the issuer is notified by a message generated by the code on the server. Monitoring of any established asset holder accounts can help to ensure a current availability of the associated prescribed asset. Likewise, the account holder can receive notifications that the terms of the pledge agreement are in default so as to provide the potential investor with an opportunity to cure the problem.

Issuer asset data can likewise be updated during database maintenance at block 655. Security values, interest rates, company valuation, and the like are kept up to date so that securities can be easily created and exchanged for capital.

Availability is ensured at block 660. One way in which to ensure availability is for the system to access the asset holder's accounts, or contact the third party guarantor pursuant to the 5S Pledge, in order to determine the availability of funds obligated under the 5S Pledge. These accounts can include bank accounts (savings, checking, etc.), brokerage accounts, credit lines, overdraft protection, and insurance contracts. If the aggregate value in these accounts surpass the value of the pledge agreement, the pledge can be considered ensured. In some implementations, the aggregate value in these accounts can be below the value of the pledge agreement by some margin, as set forth in the 5S Pledge agreement. For example, asset holders can be assigned a type, such as A, B, C, etc., that is correlated with their credit history, or some other pertinent parameter. Then, each type of asset holder can be allowed a margin by which to fall short of the pledged amount. Accordingly, pledge agreements with type “A” asset holders must hold the full obligated pledge value in the accounts, while type “B” asset holder can have a 10% margin, and type “C” asset holders can have a 30% margin. Similarly, a third party guarantor can have a analogous structure. For example, a third party guarantor with a “AA” rating can be obligated to have a 10% margin on available funds, while a third party guarantor with a “AAA” rating can be allowed a 30% margin. In yet another implementation, the server memory can contain an algorithm that calculates the degree to which the 5S Pledge is ensured.

If availability is not ensured, or not sufficiently ensured, the processor determines whether the obligation is enforceable at block 670. One method to determine enforceability is according to instructions programmed in the memory of server 120. For example, if the aggregate value in the asset holder's accounts exceeds the value of the pledge as described above, the pledge is ensured, and can be enforced if all of the authorization keys are current. Additionally, if the aggregate value in the asset holder's accounts is below the value of the pledge, the obligation is enforceable if it can be enforced in a court.

If the obligation is not enforceable, it is removed from database 130 at block 615, and the next 5S Pledge agreement is accessed from the database for maintenance at block 620. If the pledge is enforceable, the pledge remains in good standing for just-in-time financing and database 130 is updated accordingly.

The processor identifies and evaluates the pledge trigger conditions stored in database 130 at block 680. Trigger conditions include, for example, balances in the issuer's accounts decreasing below a threshold value, an increase in federal interest rates above a threshold value, an increase in security values above a threshold value, an even occurrence (such as signing a contract), among others. The processor compares each trigger condition with the status quo. If any of the trigger conditions are met, an infusion is required, and just-in-time financing is obtained, for example, as depicted at FIG. 4. On the other hand, if no trigger conditions are satisfied, the processor continues to block 690.

The processes checks whether there are any pledges that still need updating at block 690. If any pledges remain in need of updating, the next pledge in the database is chosen for maintenance at block 620, and the program loops back to block 610. The cycle continues until each pledge in the database has been maintained. When all pledges have been updated, the program returns to FIG. 2.

Additionally, some implementations of the maintenance system include code, stored in the memory of server 120 and executed by the processor, that instruct the server to send the issuer, asset holder, entity holding the asset holders' accounts, and other eligible parties, notifications with pledge agreement updates at block 695. For example, the system can send the issuer a notification one week prior to the maturity date of a 5S Pledge agreement. Since an issuer can have access to multiple 5S Pledge agreements, such a notification allows the issuer to make a better decision about which 5S Pledge agreement to draw upon. Additionally, the system can inform the issuer, asset holder, and other eligible parties, regarding substantive changes in the asset holder's or issuer's accounts, respectively, so that any interruption in the ability to draw funds is highlighted immediately, and appropriate actions can be taken.

### FIG. 4: Infusion Required

An issuer that requires an infusion of capital and has a 5S Pledge agreement with at least one asset holder can draw on the pledge, for example, according to a process such as depicted by FIG. 4. As in the previous flow diagrams, the discussion proceeds generally from the perspective of the issuer, but the program code implementing the process of FIG. 4 can be executed under control of an intermediary who stores (e.g., in the database 130) parameters and other criteria specified by account holders and any companies desiring financing. Thus, the intermediary can include the same or additional data in database 130 as illustrated in FIG. 7.

An issuer can have one or more 5S Pledge agreements, and will thus generally select to draw on the pledge, or collection or pledges, with the most favored terms and conditions. The selection process begins by determining important pledge parameters for the current financing situation at block 410. For example, the issuer can pay attention to maximum pledge value, pledge maturity date, potential ratio of debt to equity securities granted, debt interest rates, potential percentage of company ownership offered to asset holder, potential interest pay out on debt or dividends on securities, among others. In some implementations, the issuer also ranks which parameters are important and sets threshold criteria that the pledges must meet.

In certain implementations, a template for identifying pledge parameters and setting threshold criteria is programmed and stored on the memory storage unit of the server. In further implementations, the server also stores computer code with instructions for sorting the pledge parameters according to the amount of importance they should be assigned during pledge selection. In this way, the computer code assists the issuer is choosing which parameters are important during pledge selection. In additional implementations, the issuer can interact with the computer code via a device (computer, mobile device, etc.) which connects to server 120, so that the issuer can use the device as a tool in selecting favorable pledge criteria.

Pledge agreements are sorted/ranked in accordance with at least one defined criterion at block 420. The sorting process is not limited to a physical sort. Instead, the pledges can be sorted according to various algorithms which can be stored in the memory storage unit of the server. One example of sorting includes assigning a score to each pledge (the score corresponding to how well the pledge meets the pre-selected criteria), and then ranking the pledges according to their individual scores; however, any conventional sorting method can be used. In some implementations, the computer will display the proposed pledge ranking to the issuer. In this way, the issuer can override the pledge ranking computed by the server's processor (presented to the issuer by an interface on a device connected to the server via the network), or choose to remove undesirable pledge agreements from consideration.

In some implementations, standard 5S Pledge agreements of different classes were previously issued, wherein the different classes as used in this context refers to the terms of the pledge agreements as opposed to the type of assets being pledged. For example, standardized pledge agreements in classes A, B, C, and D were issued such that class “D” pledges pay, or promise to provide, a higher premium, or other form of greater compensation (e.g., relatively more stock) to the asset holder when compared with “A” class issuances. In such case, the pledges are already sorted according to the most favored terms and conditions, and server 120 can automate the sorting procedure, as well as other related functions.

At block 425 the computer code identifies one or more pledge agreements that have a higher rank than other pledge agreements, i.e., the code selects the most favored pledge agreement(s) according to the criteria laid out at block 410. The most favored pledge is often the pledge ranked highest at block 420. However, the issuer can choose a different pledge if they so desire. For example, if the second most favored pledge has a sooner maturity date, the issuer can choose to forgo the first favored pledge for the time being, and instead choose to draw upon the second favored pledge instead.

The viability of the pledge selection must be checked at block 430 prior to drawing on the pledge. Part of the validation includes determining whether the pledge is still in force (it has not reach maturity or been cancelled), whether the pledge has the current availability for infusing at least a portion of the pledged amount into the issuer account, or whether it can be ensured. The process of validating the chosen pledge agreement is described further in FIG. 5.

If the selection is not deemed viable at block 430, the code checks whether there are additional pledges for consideration at block 435. If no additional pledges are available for drawing at block 435, the program simply returns to FIG. 2, no infusion is attained, and the issuer must look for additional asset holders/investor prospects if financing/credit enhancement is desired.

On the other hand, if additional pledges are available in the list at block 435, the program simply chooses the next most favored pledge at block 440, and resumes checking its viability at block 430. As before, the issuer can override the computer's recommendation, and choose the second, or other, most favored pledge. (Additionally, the issuer can decide not to draw upon any of the remaining pledges, and return to the sequence of FIG. 2, where the issuer can attain additional asset holders.)

When a pledge is deemed viable, the issuer specifies an amount of required capital and draws on the pledge at block 445. The requested capital can be less than the amount of capital specified in the pledge agreement. In some implementations, the server sends the issuer and the asset holder a notification message that the obligated funds will be drawn from the holders account and transferred to the issuer's account in the requested amount. In some implementations, there is a waiting period during which the asset holder has time to make funds available for the issuer. In additional implementations, a drawn pledge activates the authorizations within the database, so that the pledge can be processed using defined rules and appropriate transactions can take place, for example, the transfer of capital and assets between the issuer and asset holder.

Capital can be transferred to the issuer in multiple ways at block 450. In some implementations, the issuer will have a check, a credit card, or some other physical medium by which to withdraw money. When such medium is utilized, the asset holder accounts are drawn, and database 130 is updated. In additional implementations, the server uses the above identified authorizations to access bank, credit, or other accounts. In such implementations, an instruction received at the host machine can instruct the asset holder accounts 140 to transfer at least a portion of the prescribed assets in the identified asset-holder accounts to the issuer account. In further implementations, the server generates a message to the asset holder's financial representative, such as a broker, authorizing the sale of the asset holder's securities in order to free capital for the issuer. The financial representative can thereby transfer the capital to a separate account, send a message to the server notifying that capital has been deposited into a specified account, and the server can use the authorizations that it obtained from the database to transfer capital from the asset holder's account to the issuer's account.

In the example of FIG. 4, securities are transferred to the asset holder in exchange for the deposited capital at block 460. Generally, the host machine credits the account holder with an asset of the issuer in accordance with the terms of the pledge agreement. For example, the asset holder receives securities in proportion to the amount of capital drawn by the issuer, wherein the proportion is detailed in the 5S Pledge agreement. In another example, the asset holder accounts are credited with an asset satisfying the benchmark description, in accordance with the 5S Pledge. In some implementations, the server uses the authorizations from the database to issue the securities. In other implementations, the server uses the authorizations from the database to send a message to the issuer and cause the issuer to create securities. In other implementations, the securities have already been issued, but are owned by the issuer. In still other implementations, the issuer buys back securities specifically for the purpose of transferring them to the asset holder. In some implementations, the server will send a message and an authorization to a financial entity associated with the issuer, such as an entity that manages the securities of the issuer, and that the entity will create securities or otherwise make securities available.

Once securities are available to transfer to the asset holder, they can be transferred, for example, via electronic format, sent in the mail in the form of stock or bond certificates, or other conventional means. In some implementations, the issuer-asset is priced, the account-holder is provided with a quantity of the issuer-asset determined in accordance with the pricing step, and a value of the portion of the prescribed assets is transferred to the issuer account. Upon receipt of the securities, an asset holder becomes an investor in the company associated with the issuer, in proportion to the amount of drawn capital according to the terms and conditions specified in the 5S Pledge agreement.

Depending on the terms of the pledge agreement, the transfer to the new investor at block 460 can be an instrument or asset that is not a security, such as a bond or other collateral.

In further implementations the server can hold the capital and the securities in a neutral location or a separate account until both the capital and securities are received in order to facilitate a reliable transaction.

After transfer of the capital and securities according the 5S Pledge agreement, the issuer's and asset holder's accounts are updated at block 470 to reflect the transaction.

Finally, the processor compares the amount of capital in the issuer's accounts with the amount of capital the issuer requested at block 480. If the capital in the account is more than the issuer had requested, no additional pledges need to be drawn, and the issuer can utilize the just-in-time financing according to block 260 in FIG. 2.

On the other hand, if the capital in the account is less than the issuer had requested, the processor loops to block 435, and checks whether there are additional pledges for consideration. If additional pledges are available, the processor can get the next most favored agreement, and continue in the process until a satisfactory amount of capital is raised, or there are no additional viable asset holders, as just described. If, however, no additional pledges exist, the issuer can utilize the just-in-time financing that the issuer has acquired according to block 260 in FIG. 2. However, in this case, the issuer can continue to look for additional asset holders.

### FIG. 5: Validate Pledge Selection

5S Pledge agreements selected for transfer of funds can be validated, for example, according to a process such as shown in FIG. 5.

Block 510 determines whether a 5S Pledge has been passed to the validation loop. If no 5S Pledge has been passed, the selection is deemed not viable, and the program returns to FIG. 4.

On the other hand, if a pledge has been passed to the validation loop, processor determines whether the 5S Pledge has matured, or been cancelled, at block 520. To determine maturity, the processor compares the 5S Pledge maturity date with the present date at block 520. If the maturity date is before the current date, the pledge is mature. To determine whether the pledge has been cancelled, the processor checks whether it has received a cancellation notice, in accordance with the terms and conditions of the 5S Pledge. If the pledge has matured or been cancelled, database 130 is updated at block 530, the selection is deemed not viable, and the program returns to FIG. 4.

Availability is ensured at block 550. As before, ways to ensure availability include determining whether the aggregate value of the asset holder's accounts exceeds the pledged value, and evaluating the third party backing the asset holder (guarantor, insurer, etc.). See block 660 for additional examples.

If availability is not ensured, the processor determines whether the obligation is enforceable at block 560. One method to determine whether the obligation is enforceable is to determine whether the terms and conditions of pledge are enforceable in court (see block 670 for additional examples). If the pledge is not enforceable, database 130 is updated at block 530, the selection is deemed not viable, and the program returns to FIG. 4.

On the other hand, if the obligation is enforceable, the obligation is enforced at block 570. One way to enforce the obligation is to enforce the 5S Pledge in court. Another way to enforce the obligation is to contact a third party, such as a creditor or guarantor, or to use authorizations to place a restriction on the asset holder's account. Any conventional methods of enforcing obligations can be used.

Once it is determined that availability is ensured at block 550, or that the asset holder's obligation to back the 5S Pledge is enforced, the selected pledge agreement is deemed viable, and the program returns to FIG. 4.

Currently in the art of finance, for any given investment or transaction, the investor is required to exchange his or her own funds (or some other asset type) for a share of or other right in the assets of the company and/or performance of that company. Alternatively, an entity desiring financing is required to either dilute its equity shares or increase its debt obligations to attract investment. The entity desiring financing must often do this before there is any immediate use of the funds raised. That is, there is generally a ramp-up period whereby the entity now flush with the necessary financial backing can begin the process of negotiation with suppliers and customers. This ramp-up period may be a long process whereby the funds raised are not put to use. The entity has therefore committed itself and its' investors in an undertaking that is not ready to utilize the raised funds in a profitable investment. For either party, traditional means of financing and investment are inflexible, inefficient and risky endeavors because they contain a common misconception that views actual possession of assets as the only value in initiating and concluding transactions/investments. There is therefore, no instrument that will document and utilize or enable the utilization of the value of potential possession of assets in a transaction. This invention ascribes a value to the potential possession of assets that can be represented in the form of the 5S Pledge and utilized by both the holder of the 5S Pledge and the manager.

A 5S Pledge is a contract represented by a certificate or in electronic form whereby one party, the holder of the 5S Pledge, promises to have funds (in the amount stipulated in the 5S Pledge contract) available (for a period of time or at (a) particular time(s)) to the other party, the investment manager of the 5S Pledge, should the other party require them. Generally, although it is not required, this promise is in exchange for some compensation made by the investment manager. The 5S Pledge is convertible into either a debt, equity, other security instrument, or asset upon the execution by the investment manager of his right to draw on the available funds of the 5S Pledge holder. Either party may be the writer of the 5S Pledge; however, in most transactions the party making the investment decisions (the investment manager) is the writer/issuer.

A 5S Pledge is similar to a derivative instrument. The value is derived from, among other things, the compensation that the holder has received from the writer of the 5S Pledge (if any), the value of the underlying asset and the potential/probability that the 5S Pledge has of being converted into the underlying asset.

The obligated funds of the holders can be equity or debt based so long as they are available as stipulated in the 5S Pledge contract, as indicated at blocks 350. The manager may take steps to ensure accessibility to those funds such as by third party guarantee, insurance, accessibility to the obligated funds/account and/or to other funds/accounts of the holder by both direct (direct debit, shared accounts, escrow accounts, software that reports on the availability of funds and transfers said funds when required by the manager, etc.) and indirect methods (such as through a third party). Credit card authorizations and letters of credit in favour of the manager are also examples of making available such funds in exchange for a 5S Pledge.

The method by which the issuer secures (if necessary), by perfection or otherwise, its interest/right to the funds of the holder will vary depending on the requirements of the issuer and jurisdiction. The central idea, however, remains unchanged. That is, the issuer and holder have an enforceable agreement whereby the holder is obligated to have funds available to the issuer should the issuer need or want those funds.

The status of 5S Pledge holders is not one of investor in the traditional sense since they have not or may in some instances never (depending on whether the issuer exercises his right to the holders' funds) contribute cleared funds to the issuer. They only become investors if and when the manager draws on the funds of the 5S Pledge holder such that cleared funds are transferred to the issuer.

5S Pledges are convertible into an asset of the issuer (typically debt or equity instruments) and are potentially fungible, redeemable, transferable, cancelable, etc.

Although there can be many variations on this invention, below are some of the possible forms or features of the 5S Pledge contract:
1) Cancelable: 5S Pledges can be cancelable (depending on the covenant) before maturity.
2) Transferability: 5S Pledges may be marketable/traded (publicly or privately).
3) 5S convertible stock pledge (convertible or exchangeable): whereby the 5S Pledge converts into stock of the issuer or other entity upon the manager exercising the option to draw on the promised funds of the 5S Pledge holder.
4) 5S convertible bond pledge: whereby the 5S Pledge converts into a bond of the issuer upon the manager exercising the option to draw on the promised funds of the 5S Pledge holder.
5) 5S convertible bond/stock pledge: whereby the 5S Pledge converts into a bond of the issuer upon the manager exercising the option to draw on the promised funds of the 5S Pledge holder and then at the option of the 5S Pledge holder; converts into stock of the issuer.
6) 5S convertible option bond/stock pledge: whereby the 5S Pledge converts into a bond of the issuer upon the manager exercising the option to draw on the promised funds of the 5S Pledge holder and then at the option of the issuer; converts into stock of the issuer.

Subject to the terms and conditions of the 5S Pledge contract, the 5S Pledge may be convertible at a floating, fixed or at a premium/discounted rate/price.

Furthermore, 5S Pledge contracts/prospectuses may allow holders to vote on whether a given potential investment should be pursued or change the covenants of the 5S Pledge if it is in the interest of the holders and/or the objectives of the 5S Pledge issue. In this manner they may be allowed to act as shareholders or creditors, however, it must be remembered that while they do have the obligation to provide funds if needed; they are only potential shareholders or creditors.

One method to effect the 5S Pledge transaction between issuer and holder is for the issuer to compensate the holder for the obligation to have funds available. The issuer would have the right but not the obligation to unilaterally draw on the funds of the holder and cancel the obligation of the holder. The holder, meanwhile, has the obligation to have funds available to the issuer in the amount and for the term (time period) stipulated in the 5S Pledge contract/prospectus. If funds are drawn from the holder, the holder has a right to have the 5S Pledge converted into a debt, equity, other security instrument or asset and thus become an investor as per the terms of the 5S Pledge contract/prospectus. If the 5S Pledge contract/prospectus states that the 5S Pledge issue is transferable then the holder may sell the 5S Pledge on the secondary market thereby transferring his obligation to another party. The issuer/registrar would record the transfer. In the event that the issuer does not draw on the funds of the holder; at the end of the term (upon maturity) the obligation of the holder automatically cancels and no funds are then exchanged between the issuer and the current holder.

Alternatively, the issuer may sell the 5S Pledge at a discount to the holder on credit. The credit will be for the term and in the amount stipulated in the contract. The issuer would have the right to withdraw funds from the holder during that term and up to the sale amount. The issuer may unilaterally draw on the funds of the holder and may unilaterally cancel the obligation of the holder. The holder may in turn sell the 5S Pledge on the secondary market. At the end of the term (upon maturity) the obligation of the holder automatically cancels and no funds are exchanged between the issuer and the current holder.

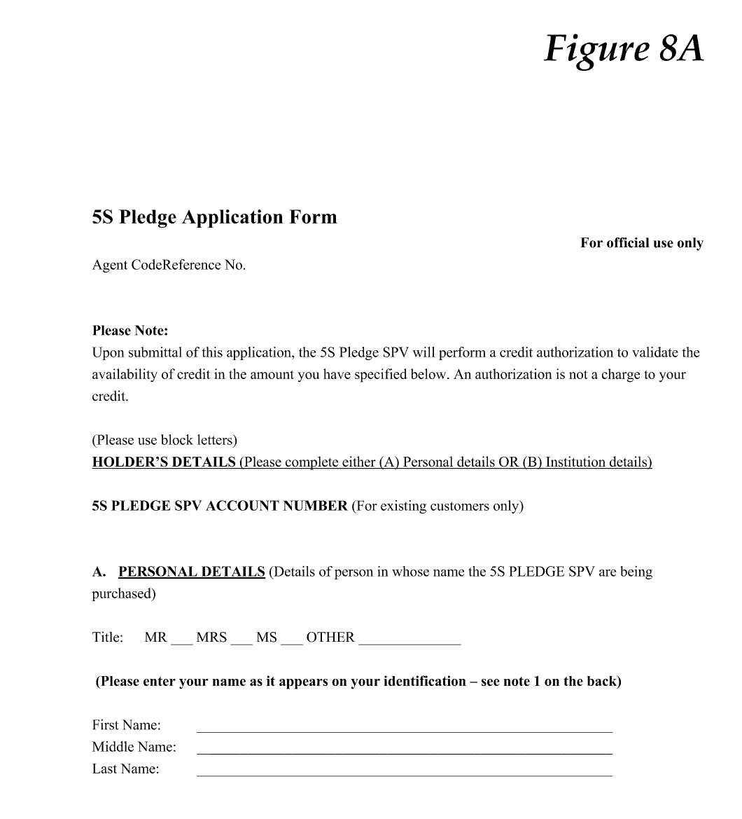

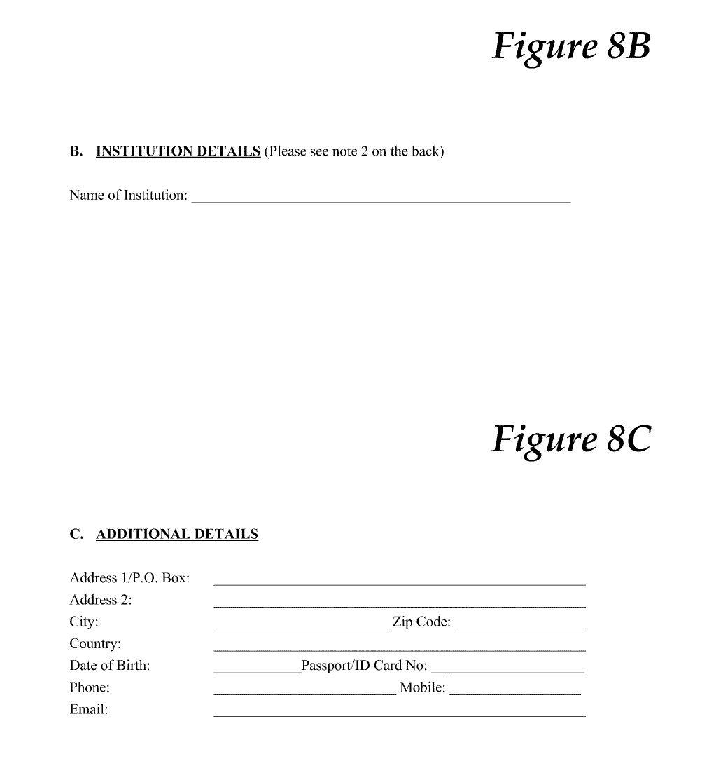

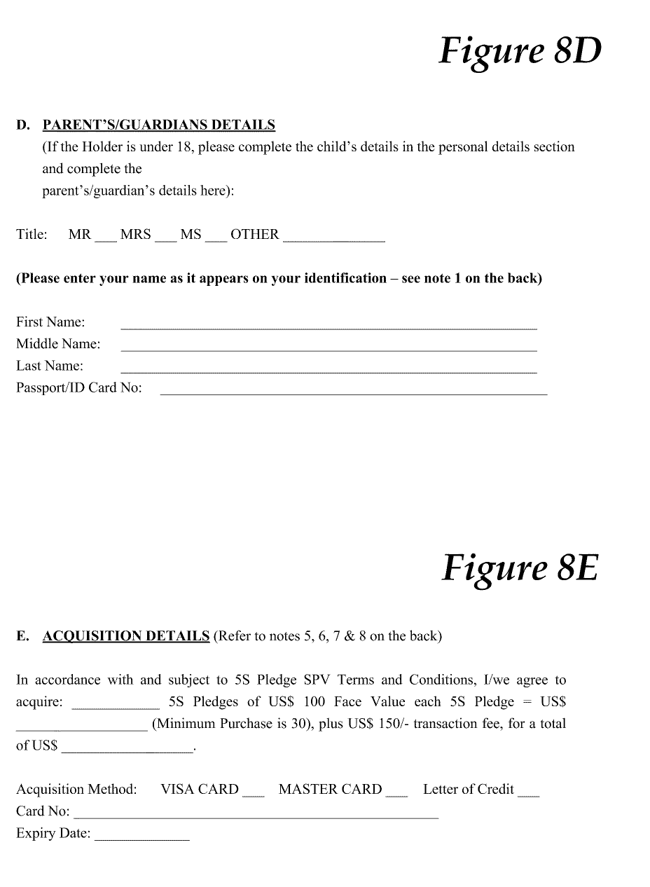

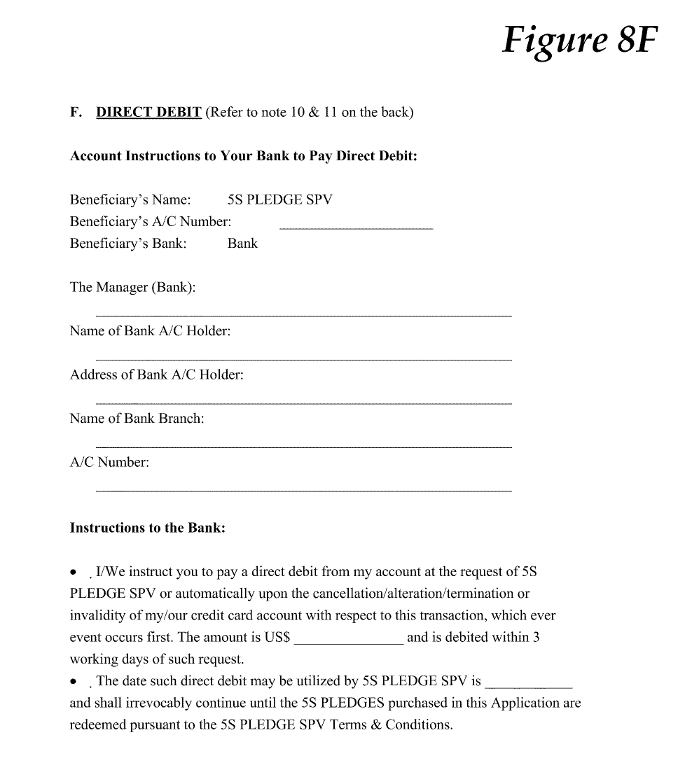

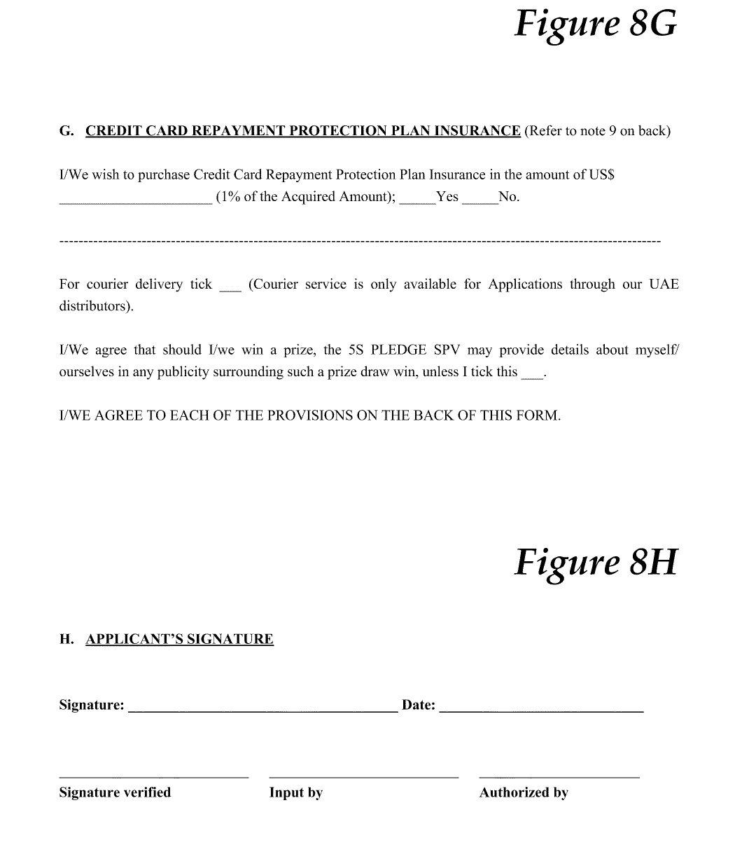

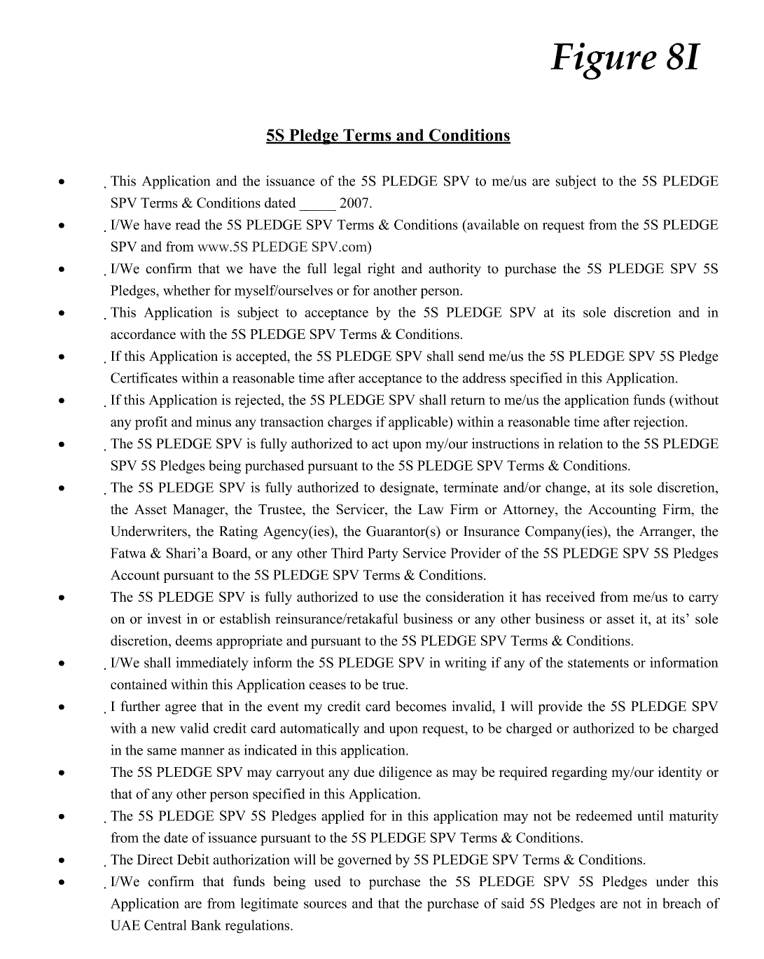

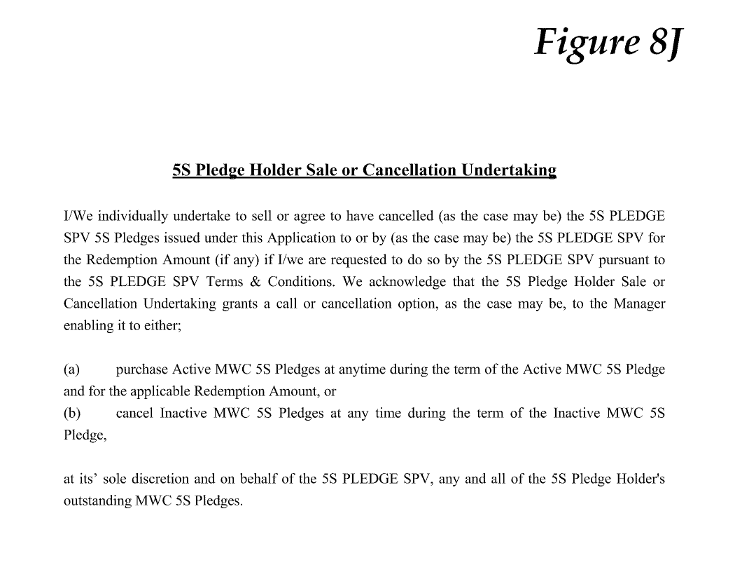

A novel method to effect a 5S Pledge transaction involves the holder purchasing the 5S Pledges using either his credit card or a letter of credit. The credit card or letter of credit would not be utilized unless needed by the manager. Instead and for example, in a credit card transaction the manager would get authorization from the credit cards' issuing bank that credit in the amount of the 5S Pledge transaction is available and the issuing bank would therefore reserve for the term of the 5S Pledge (three years for example) the amount of the transaction for the benefit of the manager should be require it. To ensure that funds were available if and when needed, the manager could also require the 5S Pledge holder to instruct his bank to automatically and directly debit his savings account should the credit card expire, terminate, or change in any material way such that the manager is unable to draw on the extended credit as stipulated in the 5S Pledge contract. The issuer may even be insured against a scenario where he is 1) unable to draw on the credit card authorization and 2) unable to directly debit the holders' account (because of insufficient funds, account closure, etc.). With this structure utilizing purchase by credit card, direct debit as a back-up measure and insurance to cover the unlikely event that both previous methods are unsatisfactory; the 5S Pledge contract becomes an instrument near to cash or is as cash equivalent. For an example of a 5S Pledge application that would be filled out by the potential holder, see FIGS. 8A through 8J, and note that the amounts and terms can be varied for any given implementation Such a 5S Pledge can include notes to the parties, terms and conditions, sale and cancellation policies, and the like, such as in examples 1A-C below.

### Example 1A

### Notes for Purchase Details to Accompany 5S Pledge

1) In the case of individuals, the following information must accompany this Application:
   Copy of the applicant's passport or identity card (driver's license, labour card, etc.) which must show the applicant's photograph and be issued by a governmental body.
   For international applicants, only a certified copy of the applicant's passport is deemed acceptable identification.
   Copy should be certified if the acquired amount is US$2,000 or more for currency exchange houses or US$40,000 or more for banks.
2) In the case of institutions, the following information must accompany this Application:
   Certified copy of the constitutive documents or trust agreement for the company or trust.
   Evidence of the applicant's address such as a copy of the tenancy contract.
   Personal details (as would be supplied by an individual) of a director, shareholder, partner, or trustee.
3) Joint applications are not accepted.
4) In the case of an applicant who is a corporate entity, trust, parent, guardian, receiver or a representative of a deceased's estate, the applicant must provide satisfactory evidentiary proof that the person signing this Application possesses the legal right and authority to do so as provided in and pursuant to the 5S PLEDGE SPV Terms & Conditions.
5) Only credit from the US issuers will be accepted.
6) All applications will be subject to Additional Charges as provided in this Application and in the 5S PLEDGE SPV Terms & Conditions.
7) The use of Credit in this transaction means that Holders will not have funds removed from their Credit Accounts except as per the 5S PLEDGE SPV Terms & Conditions.
8) A month before the credit card you have on file with the 5S PLEDGE SPV is due to expire, you shall receive a notice by email, text message, telephone call and/or post mail which will contain instructions on how to update your account information to ensure the continuity of the obligations contained within this application. If the credit card has not been renewed within 15 days before expiration, then your credit card shall be charge immediately without further notice.
9) Repayment Protection Plan Insurance that will insure the Acquired Amount only in the event that the 5S PLEDGES under the claim are Active as per the definition of the 5S PLEDGE SPV Terms & Conditions and should the following unfortunate events occur:
   Death or Permanent Total Disability
   Redundancy
   Bankruptcy
   Temporary Total Disablement
   Please note that evidentiary proof acceptable to the 5S PLEDGE SPV need be provided in order to claim for Credit Card Repayment Protection Plan Insurance.
10) Payment by Direct Debit will be utilized by the 5S PLEDGE SPV, at its sole discretion, in the event that payment by one or all of the other specified payment methods is/are ineffective or otherwise invalid and/or pursuant to the 5S PLEDGE SPV Terms & Conditions.

If the designated direct debit account is different from the credit account employed; deduct US$100/—from the transaction fee.

### Example 1B

### 5S Pledge Terms and Conditions

This Application and the issuance of the 5S PLEDGE SPV to me/us are subject to the 5S PLEDGE SPV Terms & Conditions dated 2007.
I/We have read the 5S PLEDGE SPV Terms & Conditions (available on request from the 5S PLEDGE SPV and from www.5S PLEDGE SPV.com)
I/We confirm that we have the full legal right and authority to purchase the 5S PLEDGE SPV 5S Pledges, whether for myself/ourselves or for another person.
This Application is subject to acceptance by the 5S PLEDGE SPV at its sole discretion and in accordance with the 5S PLEDGE SPV Terms & Conditions.
If this Application is accepted, the 5S PLEDGE SPV shall send me/us the 5S PLEDGE SPV 5S Pledge Certificates within a reasonable time after acceptance to the address specified in this Application.
If this Application is rejected, the 5S PLEDGE SPV shall return to me/us the application funds (without any profit and minus any transaction charges if applicable) within a reasonable time after rejection.
The 5S PLEDGE SPV is fully authorized to act upon my/our instructions in relation to the 5S PLEDGE SPV 5S Pledges being purchased pursuant to the 5S PLEDGE SPV Terms & Conditions.
The 5S PLEDGE SPV is fully authorized to designate, terminate and/or change, at its sole discretion, the Asset Manager, the Trustee, the Servicer, the Law Firm or Attorney, the Accounting Firm, the Underwriters, the Rating Agency(ies), the Guarantor(s) or Insurance Company(ies), the Arranger, the Fatwa & Shari'a Board, or any other Third Party Service Provider of the 5S PLEDGE SPV 5S Pledges Account pursuant to the 5S PLEDGE SPV Terms & Conditions.
The 5S PLEDGE SPV is fully authorized to use the consideration it has received from me/us to carry on or invest in or establish reinsurance/retakaful business or any other business or asset it, at its' sole discretion, deems appropriate and pursuant to the 5S PLEDGE SPV Terms & Conditions.
I/We shall immediately inform the 5S PLEDGE SPV in writing if any of the statements or information contained within this Application ceases to be true.
I further agree that in the event my credit card becomes invalid, I will provide the 5S PLEDGE SPV with a new valid credit card automatically and upon request, to be charged or authorized to be charged in the same manner as indicated in this application.
The 5S PLEDGE SPV may carryout any due diligence as may be required regarding my/our identity or that of any other person specified in this Application.
The 5S PLEDGE SPV 5S Pledges applied for in this application may not be redeemed until maturity from the date of issuance pursuant to the 5S PLEDGE SPV Terms & Conditions.
The Direct Debit authorization will be governed by 5S PLEDGE SPV Terms & Conditions.
I/We confirm that funds being used to purchase the 5S PLEDGE SPV 5S Pledges under this Application are from legitimate sources and that the purchase of said 5S Pledges are not in breach of UAE Central Bank regulations.

### Example 1C

### 5S Pledge Holder Sale or Cancellation Undertaking

I/We individually undertake to sell or agree to have cancelled (as the case may be) the 5S PLEDGE SPV 5S Pledges issued under this Application to or by (as the case may be) the 5S PLEDGE SPV for the Redemption Amount (if any) if I/we are requested to do so by the 5S PLEDGE SPV pursuant to the 5S PLEDGE SPV Terms & Conditions. We acknowledge that the 5S Pledge Holder Sale or Cancellation Undertaking grants a call or cancellation option, as the case may be, to the Manager enabling it to either;
(a) purchase Active MWC 5S Pledges at anytime during the term of the Active MWC 5S Pledge and for the applicable Redemption Amount, or
(b) cancel Inactive MWC 5S Pledges at any time during the term of the Inactive MWC 5S Pledge,
   at its' sole discretion and on behalf of the 5S PLEDGE SPV, any and all of the 5S Pledge Holder's outstanding MWC 5S Pledges.

Another variant would be to draw on and/or pool all 5S Pledge holders' funds into (an) escrow or other specified independently or jointly administered account(s) and have the administrator or trustee of that account administer the account according to the terms and conditions of the 5S Pledge contract. It is important to note that the 5S Pledge holders remain as 5S Pledge holder's and not investors because they have not contributed cleared funds to the manager. They shall only become investors if and when the manager has drawn on the funds that pertain to the 5S Pledge they are holding.

In a typical call option contract, the buyer of the option has the right, but not the obligation to buy an agreed quantity of a particular commodity or financial instrument (the underlying instrument) from the seller of the option at a certain time (the expiration date) for a certain price (the strike price). The seller (or “writer”) is obligated to sell the commodity or financial instrument should the buyer so decide. The buyer pays a fee (called a premium) for this right.

In a 5S Pledge on the other hand, the party with the option is the issuer, who has the right but not the obligation to withdraw funds up to an agreed amount and within a particular time frame from the holder of the 5S Pledge in order to buy/invest those assets or in a manner stipulated in the 5S Pledge prospectus. The holder is obligated to have funds available to the issuer for this purpose up to the agreed amount and for the agreed time frame. Unlike typical options, issuers need not pay an option premium to 5S Pledge holders. Instead, the issuer may sell the 5S Pledge to the holder at a discount or perhaps the issuer may sell the 5S Pledge at par because of the attractiveness of the potential investment and the ability of the holder to have the 5S Pledge converted into a security interest at a favorable price for instance. Another method would be to allow holders to receive a relatively low quarterly or yearly percentage of the profits stemming from the investment in consideration of their obligation to have funds available.

The structure of the 5S Pledge whereby holders are not investors until funds are drawn on by the manager in the event that they are required helps ensure that the issuer has a high rating and that the rating is maintained. That is, the incremental investment structure of the 5S Pledge, particularly if it is an open-ended issue, helps ensure that obligations by the issuer do not out weigh its assets. 5S Pledges allow firms to actively manage the amount of leverage they are using because of the ability of the issuer to draw on holder funds when needed, cancel or issue new 5S Pledges.

5S Pledges can be rated unlike regular/current options. Although the 5S Pledge holder is not an investor in the traditional sense, he is a holder of an instrument (the 5S Pledge) that does have value. Since holders' funds are obligated and can be drawn on unilaterally by the manager; holders may want to have or may only take on such obligations if the issuer is independently deemed to be creditworthy. In a simple collective investment scheme for example, a special purpose vehicle (SPV) issuing the 5S Pledge will contain two types of assets; 5S Pledge receivables and/or assets purchased/invested in by the manager utilizing 5S Pledge holder funds. The SPV will from the outset have only assets (5S Pledge receivables) and shall easily be able to control, if an open-ended structure is employed, the level of assets in the SPV in relation to the level of SPV liabilities such that the SPV is always highly creditworthy.

To further decrease the risk from the holders' and cost of financing from the issuers perspective, a 5S Pledge issue may have a subordinated structure. That is, different classes of 5S Pledges are made available to separate the risk of initial investment obligations of holders from subsequent investment obligations in order to increase further the SPV's credit rating.

To take this a step further, holders wishing to become early investors or wanting greater compensation for their obligation, would enter into a 5S Pledge contract that would be in the first class of 5S Pledges to be drawn on by the manager. The other classes would be drawn on only in the event that the funds from the subordinate class or classes were exhausted. This tranching of risk would allow for an even greater credit rating of some classes of 5S Pledges. Indeed, the 5S Pledge issue can have a tranching structure as can the underlying asset such as different classes of bonds which the 5S Pledge will convert into.

### Example 2

### 5S Pledge in an SPV Structure

An example of using the 5S Pledge in an SPV structure is depicted at FIG. 9, wherein a bank wishing to remove credit card receivables with a relatively low credit rating from its balance sheet sells the receivables on credit (sale on credit is a novel method to the traditional pure sale) to an SPV at block 910. In return, the bank would, in this example, by agreement with the SPV, receive a receivable from the SPV with a higher credit rating thus the bank has replaced a low credit rating receivable with a high credit rating receivable. Credit card payments would flow to the SPV.

The SPV issues 5S Pledges for the purpose of investing in credit card receivable backed securities at block 920. An example of the process for issuing 5S Pledges is depicted in FIGS. 2-6.

The asset inflows and outflows to the SPV are depicted at block 930. The SPV can comprise 5S Pledge receivables and credit card payments as assets. Liabilities can include accounts payable to the bank as well as any payments to 5S Pledge investors as opposed to holders. Compensation to holders (if any) can be paid out of the credit card payments received by the SPV.

If the SPV is open-ended and the 5S Pledges are cancelable; the SPV will enjoy a high credit rating (block 950) because of its credit based structure and the accumulation of a pool of assets (credit card payments and 5S Pledge receivables) far larger than its liabilities (block 940).

For the bank, the sale to the SPV will be treated as a true sale thereby boosting earnings for that quarter, easing balance sheet and capital constraints while increasing the credit worthiness of receivables (block 960). For holders, they receive a premium for their purchase of the 5S Pledges, they are also able to utilize their funds for other investments and they are secure in the fact that should they become investors that the investment will be in a vehicle with a good credit rating. For investors, they would be invested in a credit worthy vehicle that will either confer investment income (dividends or interest and premium payments) and/or growth (depending on the type of conversion the 5S Pledge makes).

Even though the issuer does not draw on the funds of the holder, the issuer will still benefit from the pool of available funds stemming from the 5S Pledge issue. The funds available to the manager are an asset that they may use or otherwise utilize according to the 5S Pledge contract. For the issuer, the availability and ease of access to funds in it-self permits the initiation of and reduces the barriers to entry for deal making and investment and only once deals are concluded would or may funds be drawn on according to the terms of the 5S Pledge contract.

As stated above, the issuer of the 5S Pledge may use the availability of potential funds to enter into negotiations and begin the process of reaching agreements. This is an ability that the manager/issuer would not otherwise have without the capital backing that the 5S Pledge represents. Only when investments are actually entered into (after negotiations have concluded and an agreement reached) will funds from 5S Pledge holders be drawn on.

Unlike current financing and investment, the issuer of a 5S Pledge is not obligated to the holder unless he draws on the funds of the holder. This means that the equity of the issuer will not be diluted or the obligations of the issuer will not increase until such time as is necessary for the issuer to effect some transaction.

In practice, managers would only exercise their right to draw on the funds of the holders in the event that an investment was immediately available because they would not want this dilution of equity or increase in debt.

Additionally, as a result of the lack of an obligation on the part of the issuer to provide holders with a return (depending on the terms of the 5S Pledge contract) because they are not investors in the traditional sense; the issuer is not forced to make hasty investment decisions and indeed has the opportunity to carryout as much study and negotiation as is needed in order to not only minimize the risks of investment but to also locate superior opportunities of investment. The issuer would thus require, because of the nature of the 5S Pledge structure, incremental feedback on the performance of the investment from funds already invested before increasing the amount of funds invested in any particular investment. The 5S Pledge therefore provides a much more deliberative environment within which to effect investment transactions.

Traditionally and currently, investor funds are either committed to an investment or are idle while waiting for an investment opportunity that will generate a return. Funds are often committed to the issuer before the investor or even the issuer has had an opportunity to gauge the utility of investing the funds in a particular investment. The 5S Pledge model will allow for the multiple utility of the funds of 5S Pledge contracts which results in an increased efficiency in utilization of assets and a decrease in the risk associated with investing. That is, both issuer and holder may utilize the funds simultaneously.

Holders may utilize the funds for other investments while still being obligated to the issuer to have those funds available and the issuer (depending on the terms of the 5S Pledge contract/prospectus) may leverage the 5S Pledge receivables from holders to finance other investments. That is, both the holder and the issuer may utilize the same funds to generate income and/or growth.

The terms of the 5S Pledge will vary from pledge to pledge but it is foreseeable that, as a practical matter, most such 5S Pledges will permit the funds to be used/invested by the 5S Pledge holder in only highly liquid minimum risk uses/investments.

The use of 5S Pledges by the issuer also has application as a risk management tool. Risk management is generally a pre-emptive activity that 5S Pledges can be applied to, however, 5S Pledges may also be applied to realized residual risks where it will act more like insurance. 5S Pledges may even prove to be less costly to the issuer than traditional insurance or applied to mitigate risks that traditional insurance can not or will not mitigate/cover. One such application would be to offset or insure against any decline or interruption in cash flow, an economic downturn, and/or during an unforeseen or catastrophic event. As a result, issuers will increase their credit limits and decrease their cost of credit by issuing 5S Pledges because risk of loss due to an adverse environment has been reduced.

5S Pledges mitigate against liquidity risk faced by the issuer by providing for a superior credit rating, increasing the credit rating of the issuer and/or maintaining the credit rating of the issuer. It can mitigate the impact of unexpected cash outflows and thus also mitigate any subsequent avoidance in trading with or lending to the issuer. That is, since liquidity risk or the realization of liquidity risk tends to compound other risks, the funds represented by the 5S Pledge can be employed in mitigating a significant risk that has multiple subsequent risks should liquidity ever become a problem for the issuer.

In line with the preceding paragraph, 5S Pledges may have a dampening effect on the volatility of a firms' perceived value because it makes the firm more secure by providing the firm with access to external funds when they are required. The issuance of 5S Pledges would decrease a firms' sensitivity to market risk and for the firms' issuing both 5S Pledges and other securities; the derivatives on those securities, such as typical options, would decrease in value because the value of a derivative is correlated to the volatility of the underlying asset. In general, the more volatile the asset, the more the derivative is worth. Therefore, if 5S Pledges are employed, the issuer would see the volatility of the firms' perceived value reduce with a matched reduction in derivative value.

By issuing 5S Pledges, the issuer has spread or transferred (at least partially) the risk of entry into and management of an investment onto the holders/investors. The issuer has also spread or transferred the risk of cash flow interruptions onto the holders/investors. The holders/investors represent a pool of risk retention in that the risks associated with investment by the issuer are transferred to the holders/investors who retain the risk but that retained risk has been spread over the entire pool.

5S Pledge holders have a risk of investment when the issuer decides to draw on their funds. This investment risk can be spread either by the issuer randomly selecting 5S Pledge holders to convert into investors by drawing on their funds or the issuer may divide the required funds for use/investment amongst all the 5S Pledges issued. In either case, investors would only be investors up to the amount drawn by the issuer unless some other arraignment is agreed such as “over drawing” on the funds for a premium for example or some other compensation.

Holders that become investors after sometime will benefit from the risks (risk of a faulty investment decision and risks associated with managing the early stages of the investment) borne by previous investors/holders. All holders in such a case will see that their 5S Pledge, if marketable, will have risen in value. Initial risk management and investment plans are never perfect and constantly need reviewing and revision. Indeed, the holder may obligate his or her funds at an early stage but have stipulated in the 5S Pledge contract that such funds are not to be utilized until some future date or upon some future occurrence such as a AAA credit rating granted to the issuer. The incremental nature of the 5S Pledge allows for this to happen as early investors assume the heightened risk of initial investment and risk management

Furthermore, 5S Pledge holders who become investors have a faster turn around time to realize income/gains because the funds are only used when needed and are not retained by the issuer while looking for or negotiating an investment opportunity. That is, the risk associated with investing is reduced because the time frame that the funds are committed to a particular investment is shortened. Horizon risk is therefore decreased because it shortens the period of time before the expected return is realized on the investment. If the issuer does not have any current or foreseeable investments to make, he can cancel the obligations of the holder.

To reduce equity and interest rate risk, the issuer who has issued 5S Pledges will see that since the 5S Pledge acts like insurance, it will increase the credit rating of the issuer thereby decreasing the cost of financing (both debt and equity) while at the same time increasing the value attached to the equity shares of the issuer. That is, the 5S Pledge decreases both equity and credit risk which would result in the reduction of the rate of return required by investors.

In the case of structured finance products such as asset backed securities and their variants; the 5S Pledge (i.e. the structured finance product) would allow for superior credit ratings of the SPV by not drawing on the funds of the 5S Pledge holder's unless and until needed. A credit rating agency/firm will seek to determine the risk associated with an asset backed security issue to the investor. In situations where the quantity and credit worthiness of the asset within the SPV are more than sufficient to cover the obligations of the SPV to investors, then the issue will have a superior credit rating. The benefit that the 5S Pledge has in this situation is to minimize as much as possible the obligations of the SPV to investors while retaining the benefit of the option to draw on a pool of available external funds as needed. Indeed, the credit rating can be enhanced by a number of traditional internal and external factors such as administration by an independent trustee and/or drawing on 5S Pledge holder funds only on the occurrence of predetermined “triggers”, insurance, etc.

However, unlike traditional structured finance vehicles; 5S Pledges issued out of a SPV, have a reduced or no need of a guarantor in order to increase the creditworthiness of the 5S Pledge issue because 1) the holders have not committed cleared funds to the SPV and 2) available funds from holders together with the other assets within the SPV will generally be sufficient to fully cover any obligations placed on the SPV. Indeed, a trustee could oversee and ensure that the use of holders' funds is done according to particular pre-designated triggers as stipulated in the 5S Pledge prospectus. The need and costs associated with external guarantors is therefore eliminated.

The downside risks of 5S Pledges only occur if the underlying asset value falls more than any compensation that holders have received and the issuer converts the 5S Pledge thereby causing the holder to become an investor. This risk can be mitigated for example by covenants such that the issuer becomes unable to draw on funds if the underlying assets values go below a certain point. If the issuer does not convert the 5S Pledge then there is no downside risk to the holder.

Many large financial intermediary firms (particularly since the Basel II proposal) use risk modelling to assess the amount of capital reserves to maintain, and to help guide their purchases and sales of various classes of assets. An open-ended 5S Pledge issue, for example, would allow the financial intermediary to increase its available funds when risks increase thus maintaining reserve requirements (for example) and can cancel the 5S Pledges when the risks and thus reserve requirements decrease.

### Example 3

### A Reinsurance Company Looking to Increase its Capital without Soliciting Direct Investment

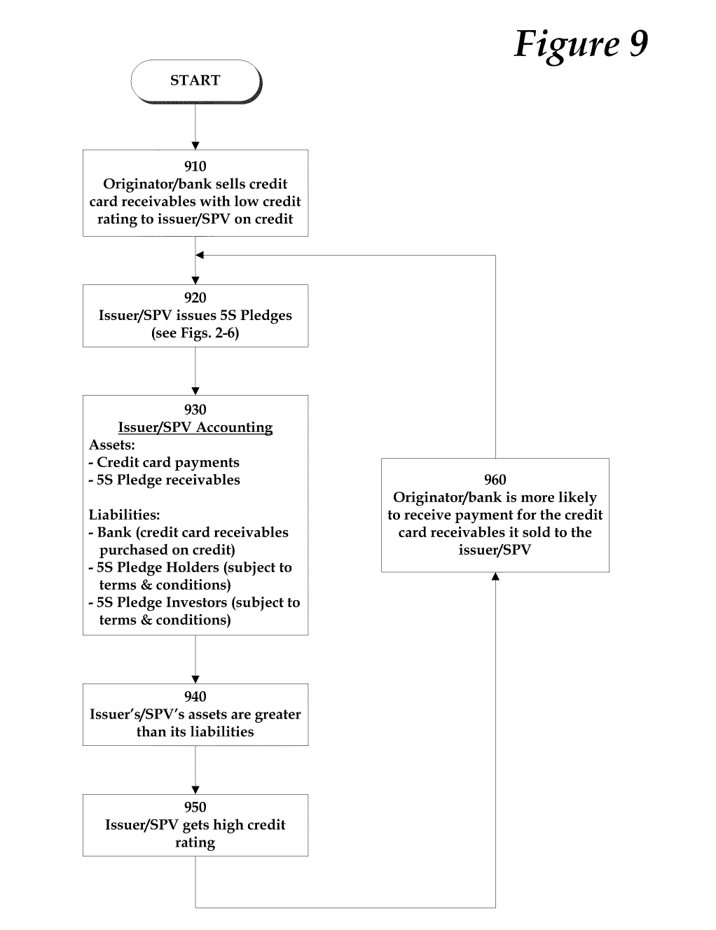

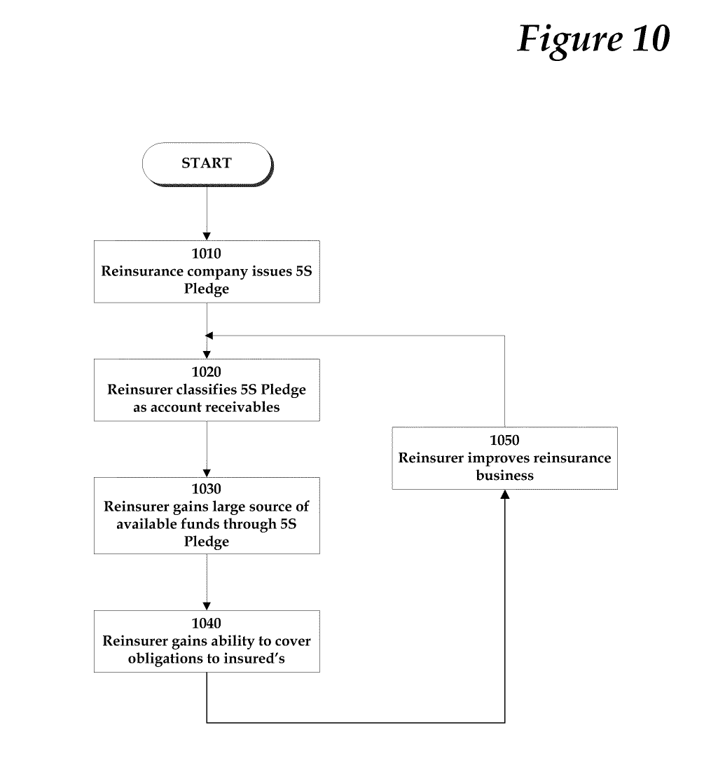

Another example of how the invention can be employed is depicted at FIG. 10: a reinsurance company looking to increase its capital without soliciting direct investment may issue, through an open-ended special purpose entity/vehicle, 5S convertible bond pledges (block 1010). The issue will be callable or cancelable depending on whether the conversion occurs. That is, for those 5S Pledges that convert into bonds, the reinsurance company has the option of calling/purchasing those bonds for a certain time period or at a certain time. For those 5S Pledges that remain unconverted, the reinsurance company has the option to cancel the 5S Pledge unless cancellation occurs automatically at maturity. The 5S Pledge in this simple case is non-transferable or redeemable.

The benefit for the insurance company is that the funds represented by the 5S Pledge issue will be classified as accounts receivable for accounting purposes (block 1020). Here, for a relatively small price, the manager gains access to a relatively large source of available funds (block 1030). If the premiums it receives from the insurance business is insufficient to cover its obligations to insured's, it has access to the funds available from the 5S Pledge issue or the available credit/credit receivable can be sold/leveraged or otherwise encumbered without directly drawing on the holders' funds in order to create liquidity (block 1040). The 5S Pledge is therefore an asset that the insurance company can utilize to increase its reinsurance business (block 1050).

The benefit to the holder in this scenario and generally is the ability to receive compensation for the obligation of their funds and to retain the ability of utilizing those same funds for other investments. Additionally, they would have a security interest in the issuer or other entity upon conversion.

### Example 4

### Application of the 5S Pledge to the Stabilization of Securities Markets

5S Pledges may be employed in ensuring stability, liquidity and investor confidence in any transaction however large or small the scale. They can be utilized in Closed System Environments or used to help develop such environments such as a particular securities market or insurance or reinsurance concern. Closed System Environments are ones where relationships between participants in the system/environment are defined, bound and regulated by in some fashion that helps to ensure performance of obligations through either contract, regulatory authority, convention, etc.

One instance of a closed system environment is a Multi-Party Organization or “MPO.” An “MPO” as used herein refers to organizations where relationships between participants in the organization are defined, bound and regulated in some fashion that helps to ensure performance of obligations through either contract, regulatory authority, convention, etc. Examples of such MPO's include NASDQ, NYSE, LSE, etc; US Federal Banking System and banking Systems in general; insurance organizations/markets such as Lloyds of London; etc. The 5S Pledge structure works very well for such multi-party organizations where individual members are benefited by their participation/association with the MPO such that it is in their interest to ensure that the MPO is protected/insured against harmful events (e.g., disruptions in liquidity).

For securities markets 5S Pledge agreements can allow the issuer to act as a market-maker and insurer by having a relatively large pool of funds available to counter act any market anomalies that may occur. The 5S Pledge is the first major innovation next to securities market regulation that may be used to counter systemic/market risk. This application is elaborated in the following example:

While specific structures, configurations and arrangements are discussed, it should be understood that this is done for illustrative purposes only. A person skilled in the pertinent art will recognize that other structures, configurations and arrangements can be used without departing from the spirit and scope of the present invention. It will be apparent to a person skilled in the art that this invention can also be employed in a variety of other ways and applications.

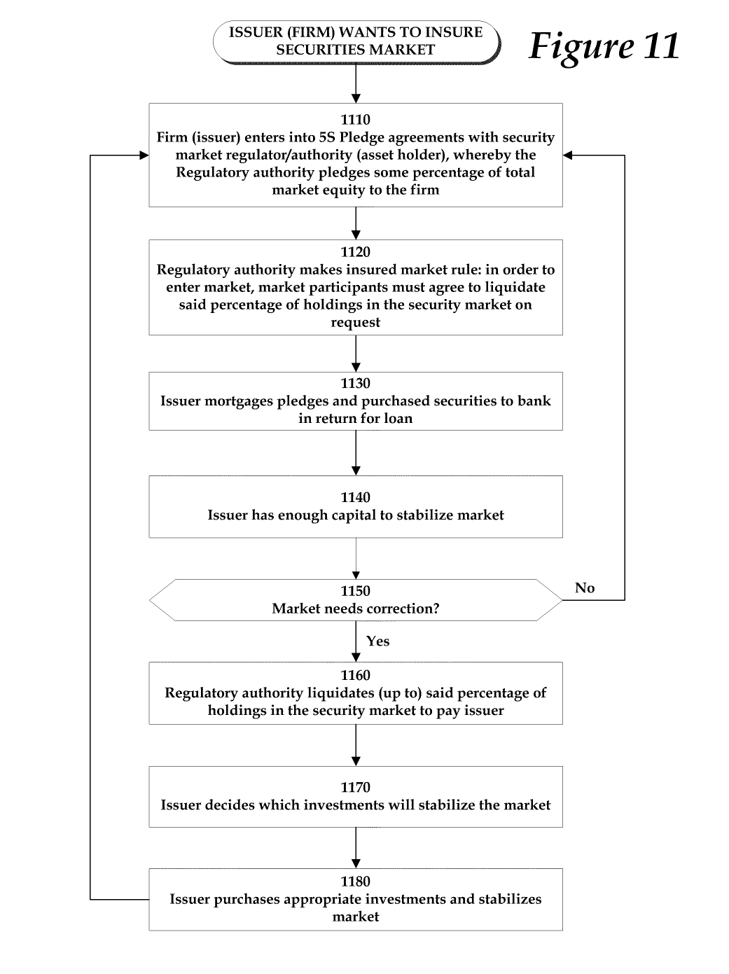

Indeed, the below structure may be used to insure and add liquidity to virtually any industry, including to the financial services, banking, investment and insurance industries. FIG. 11 illustrates the structure further.

For example, a firm (issuer) wishing to insure an entire securities market will enter into a 5S Pledge agreement with the regulatory authority of the securities market (holder) whereby the holder will agree to have available five percent (for example) of total market equity value to the issuer should it be necessary in order to stabilize/insure the security market. The size of the percentage will be based on many factors but shall generally be linked with the risk/volatility associated with the security market. The higher the risk/volatility, the larger the percentage required.

Practically, this structure will require the issuer to have agreements with most if not all market participants (broker/dealers, market-makers, listed companies, market investors, etc.) (the closed system environment) such that they agree to liquidate up to five percent of their and/or their clients' holdings in the security market (i.e. securities listed on the market) on demand from the issuer. Like any insurer, the percentage obligated (instead of the premium) will depend on the risk associated with the asset being insured. The issuer shall draw on the obligated funds of the holder when deemed necessary. The issuers' agreement with market participants may take a variety of forms and structures depending on the market, jurisdiction, culture, etc. In traditional insurance, the five percent obligation may be viewed as an insurance premium and its transfer to the issuer directly or indirectly by the holder would be non-refundable.

Under this 5S Pledge structure, the holders' funds are not transferred to the issuer unless necessary. In the event that the holders' funds are drawn on by the issuer; the drawn funds will be reinvested in an objective manner with a view to market liquidity and stability. Furthermore, the holder shall become an investor in the issuer or some other specified entity up to the amount it has contributed cleared funds to the issuer. This is due to the convertibility of the 5S Pledge into a financial debt or equity instrument.

For the issuer, the availability of the asset pool from the holder is an asset that the issuer may encumber in order to generate liquidity. The issuer will (in this example) mortgage its rights to the five percent pool of assets to a bank or syndicate of banks in return for a loan from the bank(s). It will trade in securities for its own account as an investor and/or as a market-maker and, if necessary, will mortgage the securities purchased with the loaned funds during its trading activities to generate additional liquidity. For most developed countries, margin requirements of lending institutions would allow the issuer in this example (with the five percent obligation) to be able to purchase a significant portion if not a majority of the securities listed on the insured market. The issuer will now be able to add depth and stability to the securities market. The issuer may take on this investing/insurance/market-making function itself or employ the services of an external party. The issuer or third party acting on behalf of the issuer will ensure stability by performing the combined traditional functions of an investor/insurer/market-maker with the added financial backing that the 5S Pledge represents. The issuer may prevent, for example, a rapidly declining market by purchasing securities of blue chip companies, large financial institutions, etc. To reduce the volatility engendered from irrational sell-offs.

The benefit of utilizing 5S Pledges in this security market scenario is manyfold. Securities market investors will face less risk of severe market volatility due to subjective and speculative investing and illiquidity because the issuer will have the financial ability to prevent irrational decreases and increases in the price of securities. The result of this decrease in risk will result in increased investor confidence and investment in the securities market along with a decrease in the need for decentralized investment risk management and its' attendant costs.

The purchasing power of the issuer will not change because it is based on a percentage of total market equity value. The issuer will very rarely, if ever, need to actually draw on the funds/assets of the holder which will only be used as a last resort in the event that the loaned funds from the bank(s) are insufficient to correct or balance the market. Therefore, the holder is receiving insurance and stability at no or virtually no actual cost.

Finance charges for the bank loan and other costs will be paid by the issuer from its' investing/insurance/market-making activities which should be sufficient to cover both operating and financing expenses. —I.e., Issuer can charge the market an/or market participants for 1) organizing/regulating the market, 2) insuring the market, 3) market-making activities, etc.

In another scenario, the issuer is the securities market itself or a quasi-insurance company/market maker (MM) servicing a capital market, or any other such multi-party organization. The market maker can utilize the funds derived from the 5S Pledges to either partner with, or loan to, other market makers on the system. The market maker can thus increase the liquidity and activity on the market by giving cheap and/or partial financing for securities trading to other market makers as an incentive to trade/list securities/utilize the insured market, and also reduce the risk to the securities market. For example, MM1 wants or needs $1,000 to trade on the system. The issuer can partner with MM1 in a 30/70 agreement. The issuer will then contribute 30% ($300) and MM1 will contribute 70% ($700) of the required value ($700). Any profits or losses from the transactions would be split in the same 30/70 fashion. Alternatively, the issuer can loan $300 to MM1 on favorable terms. Both are examples of ways that attracting investors and market makers can provide liquidity in excess of that provided directly by the 5S Pledge agreements.

It is not necessary that an independent firm provide this insurance/market making service to the holder (here the securities market/exchange). The securities market/exchange may perform this service in-house whereby market participants/investors become the holder(s) with the obligation to have five percent of the funds available to the securities market (issuer). The securities market/exchange as the issuer has the right to draw on the five percent (for example) available funds of the holders. In this case, the issuer is not only the securities market but is also the insurer/market maker. If funds are drawn or assets actually transferred to the issuer from the holders' account then the 5S Pledge either converts into a security (stock, bond, etc.) Of the issuer or is exchanged for a security of some other entity depending on the terms of the 5S Pledge.

Therefore, a 5S Pledge structure will allow a securities market/exchange to insure it self and/or investors/market participants. The entire structure can be made even more secure by offering market participants (holders) multiple classes of 5S Pledges. More senior levels would only be called on (i.e. Drawn on/transferred) as a last resort with the junior or subordinated 5S Pledge classes taking on the majority of the risk in return for more favourable treatment such as better relative terms of conversion or exchange to equity or debt interest.

In either event, this is the first time that a structure based on an invention has been developed that will help insure and regulate the orderly functioning of a securities market.

It must be noted that the same concept may be utilized to insure against a multitude of risks in a variety of industries and associations. Indeed an insurance company may utilize this concept whereby insured's are the holders of the 5S Pledge and the insurance company is the issuer. The issuer may mortgage the 5S Pledge obligation of the holder to generate liquidity for other investments and only draw on the actual obligated funds if needed. As in the other examples, the 5S Pledge would be convertible or exchangeable into an asset (typically either equity or debt of the issuer). Additionally, supplier, manufacture, and customer associations for example could insure themselves against business interruptions or cyclical markets or for any event not traditionally covered by insurance or for events too costly to be externally insured.

1-13. (canceled)

14. A computer implemented method for organizing pledged amounts into tranches for use by a party in a just-in-time manner for financing a transaction, comprising the steps of:
(a) establishing in a host machine connected to a distributed computer network one or more pledge agreements each having terms including (i) the pledged amount of a prescribed asset associated with an account of a respective asset holder, and (ii) a benchmark description of an asset to be acquired upon transfer of the pledged amount;
(b) confirming access to the asset-holder account over the computer network and, thereafter, monitoring over the computer network any established asset holder accounts to ensure a current availability of the associated prescribed asset;
(c) defining a tranche of pledge agreements by matching the benchmark description of any pledge agreements within the host machine;
(d) assigning beneficial ownership of the tranche to the third-party; and
(e) in response to an instruction received from the party at the host machine:
(i) processing the terms of the pledge agreements using defined rules;
(ii) identifying from among the processed pledge agreements one or more asset-holder accounts having the current availability for infusing at least a portion of the pledged amount into an account of the party;
(ii) instructing the identified accounts to transfer at least a portion of the prescribed assets in the identified asset-holder accounts to the party account; and
(iv) for each account having at least the portion of the prescribed assets transferred, crediting the account holder with an asset satisfying the benchmark description.

15. The method of claim 14, wherein the step of crediting the account-holder comprises pricing the asset that satisfies the description and providing the account-holder with a quantity of said asset determined in accordance with the pricing step and a value of the portion of the prescribed assets transferred to the party account.

16. The method of claim 15, wherein the monitoring step is performed repeatedly.
